(19) United States
(12) Patent Application Publication
(10) Pub. No.: US 2002/0083248 A1
(43) Pub. Date: Jun. 27, 2002

(54) Interleave circuit, de-interleave circuit and xDSL modem

(75) Inventor: Hiroshi Uto, Osaka (JP)

Correspondence Address: Kenneth L. Cage, Esquire, McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/021,038

(22) Filed: Dec. 19, 2001

(30) Foreign Application Priority Data
Dec. 27, 2000 (JP) 2000-397073

(51) Int. Cl. G06F 12/00

(52) U.S. Cl. 710/200

(57) ABSTRACT

When a frame length N of input data is an even number, a read address generator generates twice in succession an address at which head byte data of each frame of the input data is stored. The head byte data of each frame of the input data is thus read from a memory twice in succession. The data of the frame length (N+1) having the head byte data of each frame inserted as a dummy byte is then written to another memory according to a write address from a write address generator.

### BACKGROUND OF THE INVENTION

1. Field of the Invention

The present invention generally relates to an interleave circuit, a de-interleave circuit and an xDSL (x Digital Subscriber Line) modem. More particularly, the present invention relates to an interleave circuit adapted for a convolutional interleave method in which data is continuously rearranged regardless of the frame structure, a de-interleave circuit for restoring the data rearranged by the interleave circuit, and an xDSL modem including the interleave circuit and/or the de-interleave circuit.

2. Description of the Related Art

Recent progress in computer technology and information communications technology is remarkable, and these technologies are also increasingly widespread among general households. Moreover, digital recording technology has also made rapid progress like a high-capacity recording medium like PD and DVD (Digital Versatile Disk). High-speed, high-capacity communications are more likely to be subjected to noise-induced errors. In a recording system, slight stain or defective surface material would cause fatal errors. One method for controlling these errors is an error-correcting code. A currently used error-correcting code is divided into two types: a convolutional code and a block code. The convolutional code is mainly used in a communication system, and the block code is mainly used in a recording system. One example of the block code is a Reed-Solomon code. The Reed-Solomon coded data is normally rearranged by interleave operation. The interleave operation is conducted in order to efficiently obtain the capability of the error-correcting code by dispersing burst errors and converting them into random errors.

The ADSL (Asymmetric Digital Subscriber Line) technology defined in ITU (International Telecommunication Union) recommendations G.992.1 and G992.2 uses the Reed-Solomon code. In the ADSL, the state of a transmission path for communications varies depending on the situations. Therefore, a transmitting ADSL modem and a receiving ADSL modem together determine the code length (frame length) of the Reed-Solomon coded data and the interleave depth in an initialization routine in view of the communication state. The interleave method defined in ITU recommendations G.992.1 and G992.2 is a convolutional interleave method.

Convolutional interleave operation is normally conducted as follows: It is herein assumed that the frame length is N bytes, the byte data in each frame is B(0), B(1), B(2), . . . , B(N−1), and the interleave depth is D. First, the i^{th} byte data B(i) is transmitted with a delay of (D−1)×i. FIG. 25 shows an exemplary arrangement of the byte data before and after the interleave operation. In the example of FIG. 25, the frame length N=5 (bytes) and the interleave depth D=2.

According to ITU recommendations G.992.1 and G992.2, the interleave depth is set to 2ⁿ (where n is a positive integer). In this case, only the data having an odd frame length N before interleave operation can be subjected to the above convolutional interleave operation. When the frame length N is an even number, a dummy byte is added to the data into the frame length of (N+1) bytes, and then interleave operation is conducted. However, a conventional interleave circuit is not capable of realizing such interleave operation.

### SUMMARY OF THE INVENTION

It is an object of the present invention to provide an interleave circuit capable of implementing interleave operation according to ITU recommendations G.992.1 and G.992.2.

An interleave circuit according to one aspect of the present invention includes a first memory, a first read address generating section, a second memory, and a first write address generating section. The first memory stores a plurality of frames. Each of the plurality of frames includes N data (where N is a positive integer). The first read address generating section sequentially applies to the first memory a read address for reading each of the N data included in each frame stored in the first memory. The first write address generating section applies to the second memory a write address for writing to the second memory the data read from the first memory according to the read address from the first read address generating section. When N is an even number, the first read address generating section applies twice in succession to the first memory a read address for reading one of the N data included in each frame stored in the first memory. The first write address generating section applies as the write address to the second memory an address that is incremented by an interleave depth in response to every write access to the second memory. When N is an even number, the first write address generating section applies a sum of the number of frames that have already been transferred from the first memory to the second memory and a read address of one of the data in each frame that is first read from the first memory as a write address for writing the data first read from the first memory to the second memory. When N is an odd number, the first write address generating section applies the read address of the data first read from the first memory as the write address for writing the data first read from the first memory to the second memory.

Preferably, the interleave depth is 2ⁿ (where n is a positive integer).

In the above interleave circuit, when N is an even number, the first read address generating section applies twice in succession to the first memory a read address for reading one of the N data included in each frame stored in the first memory. As a result, the one of the N data included in each frame is read from the first memory twice in succession. (N+1) data (per frame) having the one of the N data in each frame inserted as dummy data is thus written to the second memory according to the write address from the first write address generating section. This enables the interleave operation according to ITU recommendations G.992.1 and G.992.2 to be conducted whether N is an even number or an odd number.

Preferably, when N is an even number, the first read address generating section applies to the first memory twice in succession a read address for reading head data of each frame stored in the first memory.

Preferably, the above interleave circuit further includes a register and a selector. The register stores dummy data. The selector selectively applies to the second memory the dummy data stored in the register or the data read from the first memory. When N is an even number, the selector applies to the second memory the dummy data stored in the register instead of the one of the N data that is read twice in succession from the first memory.

Preferably, each of the N data included in each of the plurality of frames is byte data.

A de-interleave circuit according to another aspect of the present invention is a circuit for de-interleaving data interleaved by the above interleave circuit. The de-interleave circuit includes a third memory, a second read address generating section, a fourth memory, and a second write address generating section. The third memory stores the data interleaved by the interleave circuit. The second read address generating section applies to the third memory a read address for reading each of the data stored in the third memory. The second write address generating section applies to the fourth memory a write address for writing to the fourth memory the data read from the third memory according to the read address from the second read address generating section. The second read address generating section applies as the read address to the third memory an address that is incremented by the interleave depth in response to every read access to the third memory. When N is an even number, the second read address generating section applies a sum of the number of frames that have already been transferred from the third memory to the fourth memory and a write address for writing one of the data in each frame that is first read from the first memory of the interleave circuit to the fourth memory as a read address for reading from the third memory the data first read from the first memory. When N is an odd number, the second read address generating section applies the write address for writing the data that is first read from the first memory to the fourth memory as the read address for reading from the third memory the data first read from the first memory. When N is an even number, the second write address generating section applies twice in succession to the fourth memory a write address for writing the one of the N data that is read twice in succession from the first memory of the interleave circuit.

In the above de-interleave circuit, when N is an even number, the one of the N data that is read twice in succession from the first memory of the interleave circuit is written to the same address of the fourth memory twice in succession. Thus, the dummy data inserted by the interleave circuit can be removed. As a result, the data rearranged by the interleave operation of the interleave circuit can be restored to the original data (i.e., the data before the interleave operation).

An xDSL modem according to still another aspect of the present invention includes the above interleave circuit.

An xDSL modem according to yet another aspect of the present invention includes the above de-interleave circuit.

An interleave circuit according to a further aspect of the present invention includes a first memory, a write address generating section, a first address register, and a first adder. The write address generating section sequentially applies to the first memory a write address for writing each of N data included in each of a plurality of frames (where N is a positive integer). The first address register generates, when N is an odd number, a value that has an initial value “0” and that is incremented by N every time N data are written to the first memory, and generates, when N is an even number, a value that has an initial value equal to an interleave depth and that is incremented by (N+1) every time N data are written to the first memory. The first adder increments the write address from the write address generating section by the interleave depth in response to every write access to the first memory. The write address generating section applies an output of the first address register as a write address for writing head data of each frame to the first memory, and applies an output of the first adder as a write address for writing data other than the head data of each frame to the first memory.

Preferably, the interleave depth is 2ⁿ (where n is a positive integer).

According to the above interleave circuit, the interleave operation can be conducted whether N is an even number or an odd number. In other words, the interleave operation according to ITU recommendations G.992.1 and G.992.2 can be conducted whether N is an even number or an odd number.

Preferably, each of the N data included in each of the plurality of frames is byte data.

A de-interleave circuit according to a still further aspect of the present invention is a circuit for de-interleaving data interleaved by the above interleave circuit. The de-interleave circuit includes a second memory, a read address generating section, a second address register, and a second adder. The second memory stores the data interleaved by the interleave circuit. The read address generating section applies to the second memory a read address for reading each data stored in the second memory. The second address register generates, when N is an odd number, a value that has an initial value “0” and that is incremented by N every time N data are read from the second memory, and generates, when N is an even number, a value that has an initial value equal to the interleave depth and that is incremented by (N+1) every time N data are read from the second memory. The second adder increments the read address from the read address generating section by the interleave depth in response to every read access to the second memory. The read address generating section applies an output of the second address register to the second memory as a read address every time N data are read from the second memory, and otherwise applies an output of the second adder to the second memory as a read address.

The above de-interleave circuit implements the de-interleave operation by switching a read-address generation and control mechanism and a write-address generation and control mechanism of the above interleave circuit with each other. As a result, the data rearranged by the interleave operation of the above interleave circuit can be restored to the original data (i.e., the data before the interleave operation).

An xDSL modem according to a yet further aspect of the present invention includes the above interleave circuit.

An xDSL modem according to a yet further aspect of the present invention includes the above de-interleave circuit.

### BRIEF DESCRIPTION OF THE DRAWINGS

FIG. 1 is a block diagram of the overall structure of an interleave circuit according to a first embodiment of the present invention;

FIG. 2 shows an input data structure;

FIG. 3 is a timing chart illustrating operation of the interleave circuit of FIG. 1 when the frame length is an even number;

FIG. 4 shows the correspondence of data before and after interleave operation;

FIG. 5 is a timing chart illustrating operation of the interleave circuit of FIG. 1 when the frame length is an odd number;

FIG. 6 shows the correspondence of data before and after interleave operation;

FIG. 7 is a block diagram of the overall structure of an interleave circuit according to a modification of the first embodiment;

FIG. 8 is a timing chart illustrating operation of the interleave circuit of FIG. 7 when the frame length is an even number;

FIG. 9 is a block diagram of the overall structure of a de-interleave circuit according to a second embodiment of the present invention;

FIG. 10 is a timing chart illustrating operation of the de-interleave circuit of FIG. 9 when the frame length is an even number;

FIG. 11 shows the correspondence of data before and after de-interleave operation;

FIG. 12 is a timing chart illustrating operation of the de-interleave circuit of FIG. 9 when the frame length is an odd number;

FIG. 13 shows the correspondence of data before and after de-interleave operation;

FIG. 14 is a block diagram of the overall structure of an interleave circuit according to a third embodiment of the present invention;

FIG. 15 is a timing chart illustrating operation of the interleave circuit of FIG. 14 when the frame length is an even number;

FIG. 16 shows the correspondence of data before and after interleave operation;

FIG. 17 is a timing chart illustrating operation of the interleave circuit of FIG. 14 when the frame length is an odd number;

FIG. 18 shows the correspondence of data before and after interleave operation;

FIG. 19 is a block diagram of the overall structure of a de-interleave circuit according to a fourth embodiment of the present invention;

FIG. 20 is a timing chart illustrating operation of the de-interleave circuit of FIG. 19 when the frame length is an even number;

FIG. 21 shows the correspondence of data before and after de-interleave operation;

FIG. 22 is a timing chart illustrating operation of the de-interleave circuit of FIG. 19 when the frame length is an odd number;

FIG. 23 shows the correspondence of data before and after de-interleave operation;

FIG. 24 is a block diagram of the structure of an ADSL modem according to a fifth embodiment of the present invention; and

FIG. 25 shows the byte data arrangement before and after convolutional interleave operation.

### DESCRIPTION OF THE PREFERRED EMBODIMENTS

Hereinafter, embodiments of the present invention will be described in detail in conjunction with the accompanying drawings. Note that the same or corresponding portions are denoted with the same reference numerals and characters throughout the figures, and description thereof will not be repeated.

(First Embodiment)

[Structure of Interleave Circuit]

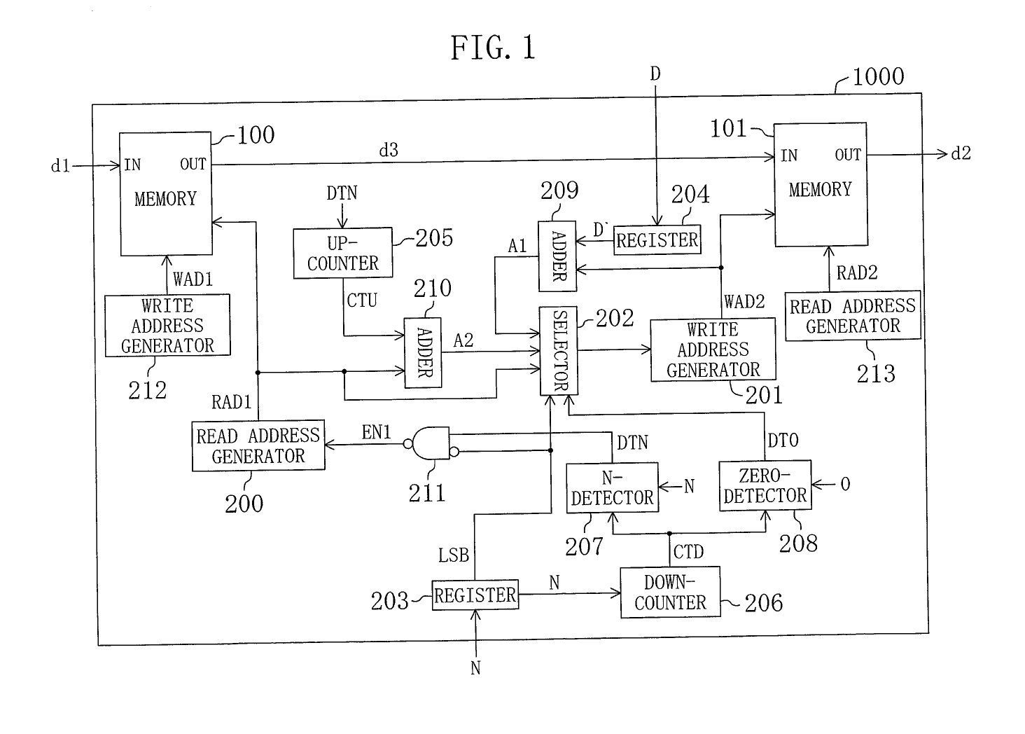

FIG. 1 is a block diagram of the overall structure of an interleave circuit according to the first embodiment of the present invention. The interleave circuit 1000 of FIG. 1 is a convolutional interleave circuit for continuously rearranging input data d1 regardless of the frame structure and outputting the resultant data as output data d2. The interleave circuit 1000 includes memories 100, 101, read address generators 200, 213, write address generators 201, 212, a selector 202, registers 203, 204, an up-counter 205, a down-counter 206, an N-detector 207, a zero-detector 208, adders 209, 210, and an enable signal generator 211.

External input data d1 is written to the memory 100 according to a write address WAD1 from the write address generator 212. The data written to the memory 100 is read according to a read address RAD1 from the read address generator 200. The data d3 thus read from the memory 100 is written to the memory 101 according to a write address WAD2 from the write address generator 201. The data written to the memory 101 is read according to a read address RAD2 from the read address generator 213. The data d2 thus read from the memory 101 is output to the outside.

The register 203 stores a frame length N applied from the outside. The frame length N indicates the number of data included in each frame of the input data d1. The register 204 stores an interleave depth D applied from the outside.

The write address generator 212 outputs a write address WAD1. The write address generator 212 increments the write address WAD1 by 1 in response to every write access to the memory 100. It is herein assumed that the initial value of the write address WAD1 is zero.

In response to every read access to the memory 100, the down-counter 206 decrements the frame length N stored in the register 203 and having its least significant bit replaced with 1 minus 1 by 1 for output.

The N-detector 207 outputs an active (logical high level) detection signal DTN when the output CTD of the down-counter 206 matches N. Otherwise, the N-detector 207 outputs an inactive (logical low level) detection signal DTN.

The zero-detector 208 outputs an active (logical high level) detection signal DT0 when the output CTD of the down-counter 206 matches zero. Otherwise, the zero-detector 208 outputs an inactive (logical low level) detection signal DT0.

The enable signal generator 211 outputs an inactive (logical low level) enable signal EN1 when the detection signal DTN from the N-detector 207 is at logical high level and the least significant bit LSB of the frame length N stored in the register 203 is zero (at logical low level). Otherwise, the enable signal generator 211 outputs an active (logical high level) enable signal EN1.

The read address generator 200 outputs a read address RAD1. When the enable signal EN1 from the enable signal generator 211 is active, the read address generator 200 increments the read address RAD1 by 1 in response to every read access to the memory 100. When the enable signal EN1 is inactive, the read address generator 200 does not increment the read address RAD1. It is herein assumed that the initial value of the read address RAD1 is zero.

The up-counter 205 counts the number of frames transferred from the memory 100 to the memory 101 (including a frame being transferred) for output. More specifically, the up-counter 205 increments the count value CTU by 1 in response to every reception of an active detection signal DTN from the N-detector 207. It is herein assumed that the initial value of the count value CTU is zero.

The adder 210 adds the count value CTU of the up-counter 205 and the read address RAD1 from the read address generator 200. The adder 209 adds the interleave depth D stored in the register 204 and the write address WAD2 from the write address generator 201.

In response to the detection signal DT0 from the zero-detector 208 and the least significant bit LSB of the frame length N stored in the register 203, the selector 202 selects one of the output A1 of the adder 209, the output A2 of the adder 210 and the read address RAD1 for output. More specifically, when the detection signal DT0 from the zero-detector 208 is inactive, the selector 202 selects the output A1 of the adder 209 for output. When the detection signal DT0 from the zero-detector 208 is active and the least significant bit LSB of the frame length N is zero, the selector 202 selects the output A2 of the adder 210 for output. When the detection signal DT0 from the zero-detector 208 is active and the least significant bit LSB of the frame length N is 1, the selector 202 selects the read address RAD1 for output.

The write address generator 201 outputs the output of the selector 202 as write address WAD2. It is herein assumed that the initial value of the write address WAD2 is zero. The write address WAD2 is incremented by +D in response to every write access to the memory 101.

The read address generator 213 outputs a read address RAD2. The read address generator 213 increments the read address RAD2 by 1 in response to every read access to the memory 101. It is herein assumed that the initial value of the read address RAD2 is zero.

[Operation of Interleave Circuit]

Hereinafter, operation of the interleave circuit 1000 thus structured will be described.

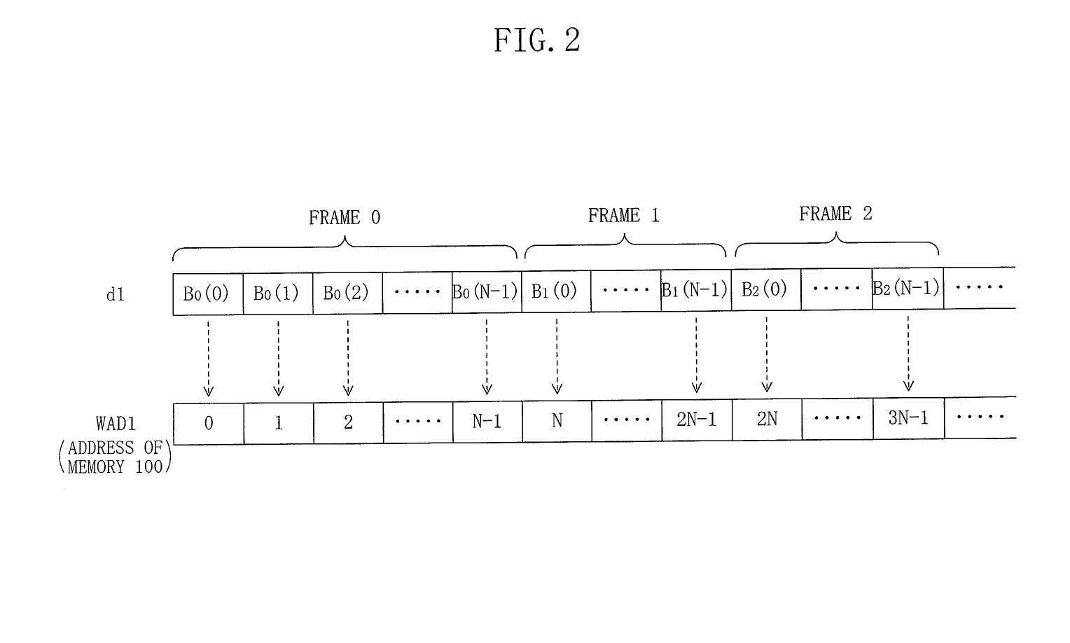

Input data d1 is applied from the outside to the interleave circuit 1000. As shown in FIG. 2, the input data d1 is a data string including a plurality of frames. Each frame includes N byte data B(0) to B(N−1). Accordingly, the number of data included in each frame of the input data d1, that is, the frame length of the input data d1, is N. The input data d1 is sequentially applied in the following order: byte data B₀(0), B₀(1), . . . , B₀(N−1) of frame 0, byte data B₁(0), B₁(1), . . . , B₁(N−1) of frame 1, byte data B₂(0), . . . of frame 2 and the like. The input data d1 is sequentially written to the memory 100 on a byte-by-byte basis according to the write address WAD1 from the write address generator 212. More specifically, as shown in FIG. 2, byte data B₀(0) of frame 0 is written to address 0 of the memory 100, byte data B₀(1) of frame 0 is written to address 1 thereof, byte data B₀(N−1) of frame 0 is written to address (N−1) thereof, byte data B₁(0) of frame 1 is written to address N thereof, and the like. The frame length N of the input data d1 is applied to the register 203, and the interleave depth D is applied to the register 204. The interleave depth D is herein set to 2ⁿ (where n is a positive integer). Description will now be given for the cases where the frame length N of the input data d1 is an even number and an odd number.

(a) When the Frame Length N is an Even Number

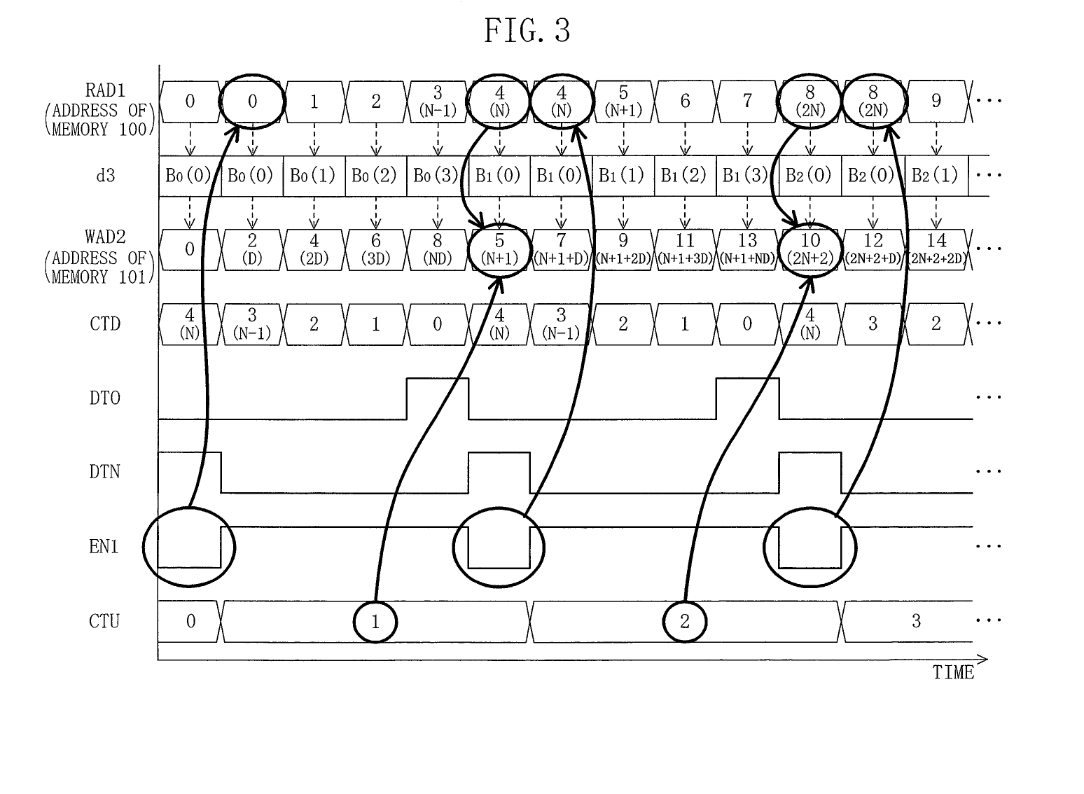

Hereinafter, description will be given with reference to FIG. 3. It is herein assumed that the frame length N is 4 and the interleave depth D is 2.

The initial value “0” of the read address RAD1 is applied from the read address generator 200 to the memory 100. In response to this, byte data B₀(0) is read from address 0 of the memory 100. The initial value “0” of the write address WAD2 is then applied from the write address generator 201 to the memory 101. In response to this, the byte data B₀(0) read from the memory 100 is written to address 0 of the memory 101. Since the frame length N (=4) is an even number, the initial value of the output CTD of the down-counter 206 is 4 (=N). Since the output CTD of the down-counter 206 is 4 (=N), the output DTN of the N-detector 207 goes to logical high level. The least significant bit LSB of the frame length N (=4) is zero. Therefore, the enable signal EN1 goes to logical low level. In response to the logical low level enable signal EN1, the read address generator 200 stops updating (incrementing) the read address RAD1.

The initial value “0” of the read address RAD1 is again applied from the read address generator 200 to the memory 100. In response to this, byte data B₀(0) is again read from address 0 of the memory 100. The selector 202 selects the output A1 of the adder 209 for output. Accordingly, the write address WAD2 incremented by the interleave length D (=2) is applied from the write address generator 201 to the memory 101. In other words, the write address generator 201 applies address 2 (=D) to the memory 101 as write address WAD2. In response to this, the byte data B₀(0) read from the memory 100 is written to address 2 (=D) of the memory 101. The output CTD of the down-counter 206 becomes 3 (=N−1). In response to this, the output DTN of the N-detector 207 goes to logical low level, and the enable signal EN1 goes to logical high level. In response to the logical high level enable signal EN1, the read address generator 200 increments the read address RAD1 by 1.

Address 1 is applied to the memory 100 as read address RAD1. In response to this, byte data B₀(1) is read from address 1 of the memory 100. The write address WAD2 incremented by the interleave depth D (=2), i.e., address 4 (=2D), is applied from the write address generator 201 to the memory 101. In response to this, the byte data B₀(1) read from the memory 100 is written to address 4 (=2D) of the memory 101. The output CTD of the down-counter 206 becomes 2. The enable signal EN1 remains at logical high level. In response to the logical high level enable signal EN1, the read address generator 200 increments the read address RAD1 by 1.

Address 2 is applied to the memory 100 as read address RAD1. In response to this, byte data B₀(2) is read from address 2 of the memory 100. The write address WAD2 incremented by the interleave depth D (=2), i.e., address 6 (=3D), is applied from the write address generator 201 to the memory 101. In response to this, the byte data B₀(2) read from the memory 100 is written to address 6 (=3D) of the memory 101. The output CTD of the down-counter 206 becomes 1. The enable signal EN1 remains at logical high level. In response to the logical high level enable signal EN1, the read address generator 200 increments the read address RAD1 by 1.

Address 3 (=N−1) is applied to the memory 100 as read address RAD1. In response to this, byte data B₀(3) is read from address 3 of the memory 100. The write address WAD2 incremented by the interleave depth D (=2), i.e., address 8 (=ND), is applied from the write address generator 201 to the memory 101. In response to this, the byte data B₀(3) read from the memory 100 is written to address 8 (=ND) of the memory 101. The output CTD of the down-counter 206 becomes zero. The enable signal EN1 remains at logical high level. In response to the logical high level enable signal EN1, the read address generator 200 increments the read address RAD1 by 1.

Address 4 (=N) is applied to the memory 100 as read address RAD1. In response to this, byte data B₁(00) is read from address 4 (=N) of the memory 100. Since the output CTD of the down-counter 206 is zero, the output DT0 of the zero-detector 208 responsively goes to logical high level. The least significant bit LSB of the frame length N is zero. Therefore, the selector 202 selects the output A2 of the adder 210 for output. The sum of the read address RAD1 (=4=N) and the output CTU (=1) of the up-counter 205 (i.e., 5=N+1) is thus applied from the write address generator 201 to the memory 101 as write address WAD2. In response to this, the byte data B₁(00) read from the memory 100 is written to address 5 (=N+1) of the memory 101. The output CTD of the down-counter 206 is reset to the initial value 4 (=N). Thereafter, the same process as that described above is repeated.

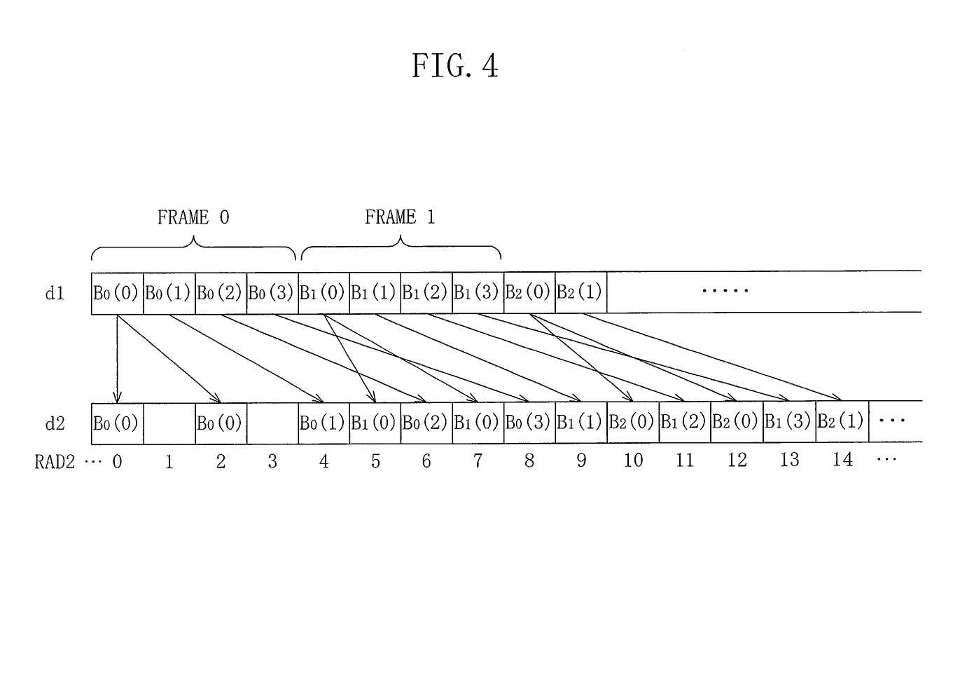

The byte data stored in the memory 101 is read according to the read address RAD2 from the read address generator 213. More specifically, byte data is sequentially read from address 0, address 1, address 2, address 3, and the like of the memory 101. The data thus read from the memory 101 is output to the outside as output data d2. As shown in FIG. 4, the input data d1 is rearranged into output data d2 by the interleave operation of the interleave circuit 1000.

Thus, when the frame length N is an even number, the head byte data in each frame of the input data d1 is read twice in succession from the memory 100 so as to be inserted as a dummy byte for the interleave operation.

(b) When the Frame Number N is an Odd Number

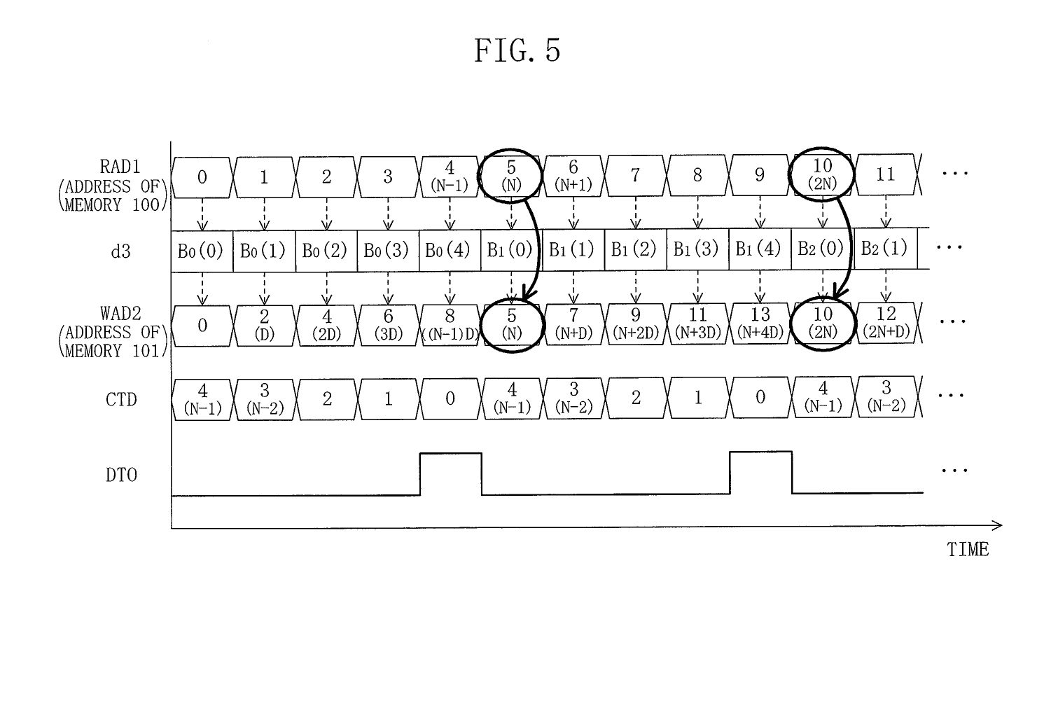

Description will now be given with reference to FIG. 5. It is herein assumed that the frame length N is 5 and the interleave depth D is 2.

The initial value “0” of the read address RAD1 is applied from the read address generator 200 to the memory 100. In response to this, byte data B₀(0) is read from the address 0 of the memory 100. The initial value “0” of the write address WAD2 is applied from the write address generator 201 to the memory 101. In response to this, the byte data B₀(0) read from the memory 100 is written to address 0 of the memory 101. Since the frame length N (=5) is an odd number, the initial value of the output CTD of the down-counter 206 is 4 (=N−1). The least significant bit LSB of the frame length N (=5) is 1. Accordingly, the enable signal EN1 is always at logical high level. In response to the logical high level enable signal EN1, the read address generator 200 increments the read address RAD1 by 1.

Address 1 is applied to the memory 100 as read address RAD1. In response to this, byte data B₀(1) is read from address 1 of the memory 100. The selector 202 selects the output A1 of the adder 209 for output. Accordingly, the write address WAD2 incremented by the interleave depth D (=2), i.e., address 2 (=D), is applied from the write address generator 201 to the memory 101. In response to this, the byte data B₀(1) read from the memory 100 is written to address 2 (=D) of the memory 101.

According to the same transfer process as that of byte data B₀(1), byte data B₀(2), B₀(3) and B₀(4) stored in addresses 2, 3 and 4 of the memory 100 are written to addresses 4 (=2D), 6 (=3D) and 8 (=4D) of the memory 101, respectively.

Once N (=5) byte data B₀(0) to B₀(4) are transferred from the memory 100 to the memory 101, the output CDT of the down counter 206 becomes zero, and the detection signal DT0 goes to logical high level. Since the enable signal EN1 remains at logical high level, the read address generator 200 increments the read address RAD1 by 1. The address 5 (=N) is then applied to the memory 100 as read address RAD1. In response to this, byte data B₁(0) is read from address 5 (=N) of the memory 100. Since the detection signal DT0 is at logical high level and the least significant bit LSB of the frame length N is 1, the selector 202 selects the read address RAD1 for output. The read address RAD1 (=5=N) is thus applied from the write address generator 201 to the memory 101 as write address WAD2. In response to this, byte data B₁(0) read from the memory 100 is written to address 5 (=N) of the memory 101. The output CTD of the down-counter 206 is reset to the initial value 4 (=N−1). Thereafter, the same process as that described above is repeated.

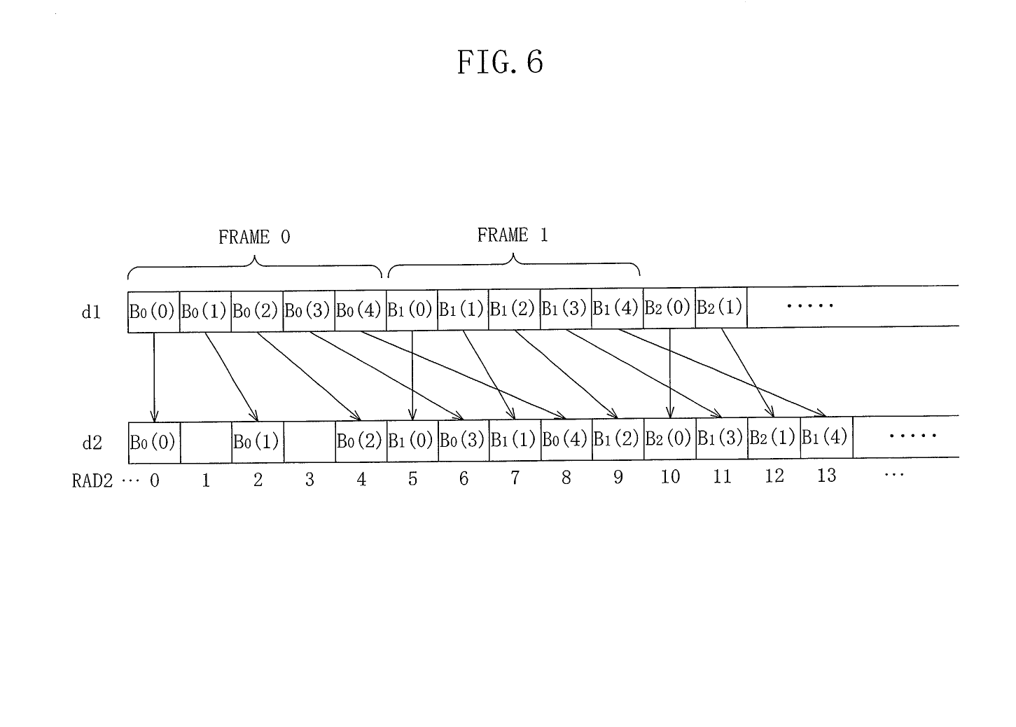

The byte data stored in the memory 101 is read according to the read address RAD2 from the read address generator 213. More specifically, the byte data is sequentially read from address 0, address 1, address 2, address 3 and the like of the memory 101. The data thus read from the memory 101 is output to the outside as output data d2. As shown in FIG. 6, the input data d1 is rearranged into output data d2 by the interleave operation of the interleave circuit 1000.

[Effects]

As has been described above, in the interleave circuit of the first embodiment, the read address generator 200 generates twice in succession the address at which the head byte data of each frame of the input data d1 is stored. The head byte data of each frame of the input data d1 is thus read from the memory 100 twice in succession. Data d3 of the frame length (N+1) having the head byte data of each frame inserted as a dummy byte is then written to the memory 101 according to the write address WAD2 from the write address generator 201. As a result, the interleave operation according to ITU recommendations G.992.1 and G.992.2 can be conducted whether the frame length N of the input data d1 is an even number or an odd number.

[Modification]

Note that the above description is given for the case where the frame length N of the input data d1 is 4 and 5. However, the interleave operation can be conducted in the same manner as that described above even when the input data d1 has another frame length N.

Moreover, the above description is given for the case where the interleave depth D is 2. However, the interleave operation can be conducted in the same manner as that described above even when the interleave depth D has another value (where D is 2ⁿ (n is a positive integer)).

In the above description, the head byte data of each frame of the input data d1 is read twice in succession from the memory 100 so as to be inserted as a dummy byte. Alternatively, another byte data of each frame of the input data d1 may be read twice in succession from the memory 100 so as to be inserted as a dummy byte.

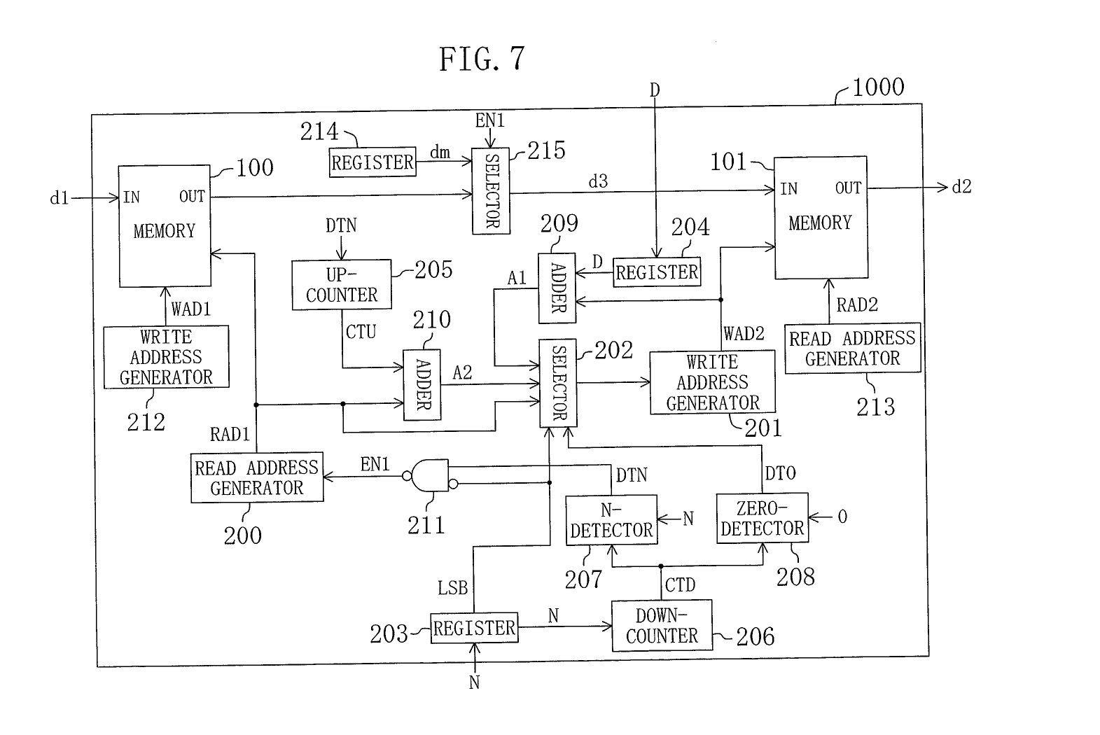

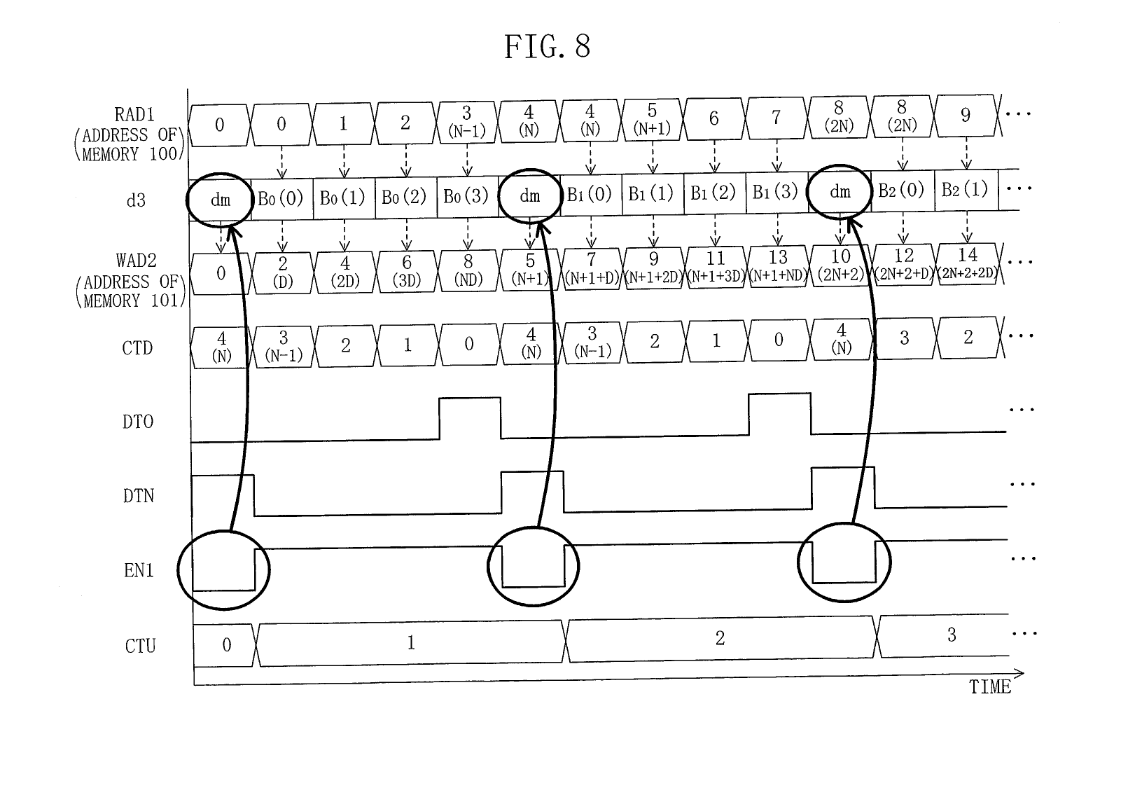

In the above description, the head byte data of each frame of the input data d1 is inserted as a dummy byte. Alternatively, exclusive dummy byte data dm may be inserted. More specifically, as shown in FIG. 7, a register 214 and a selector 215 are provided in addition to the structure of the interleave circuit 1000 of FIG. 1. The register 214 stores the exclusive dummy byte data dm. When the enable signal EN1 is at logical high level, the selector 215 applies the byte data read form the memory 100 to the memory 101 as data d3. When the enable signal EN1 is at logical low level, the selector 215 applies the dummy byte dm stored in the register 214 to the memory 101 as data d3. As shown in FIG. 8, the dummy byte dm is thus inserted instead of the head byte data of each frame of the input data d1. This modification is also capable of implementing the same functionality as that of the interleave circuit of FIG. 1.

Another structure is also possible in order to reduce the memory region to be used in the memories 100, 101 as much as possible. More specifically, the read address generators 200, 213 and the write address generators 201, 212 may be structured as follows: If the frame length N is an odd number, the read addresses RAD1, RAD2 and the write addresses WAD1, WAD2 are reset to the initial value “0” when they exceed (frame length N)×(interleave depth D). If the frame length N is an even number, the read addresses RAD1, RAD2 and the write addresses WAD1, WAD2 are reset to the initial value “0” when they exceed (N+1)×D. In this case, the up-counter 205 is structured so as to reset the count value CTU to the initial value “0” when it exceeds the value (D−1). The memory region to be used in the memories 100, 101 is thus N×D bytes when the frame length N is an odd number, and (N+1)×D bytes when the frame length N is an even number.

The memories 100, 101 may be replaced with FIFO (First-In First-Out) buffers.

(Second Embodiment)

[Structure of De-Interleave Circuit]

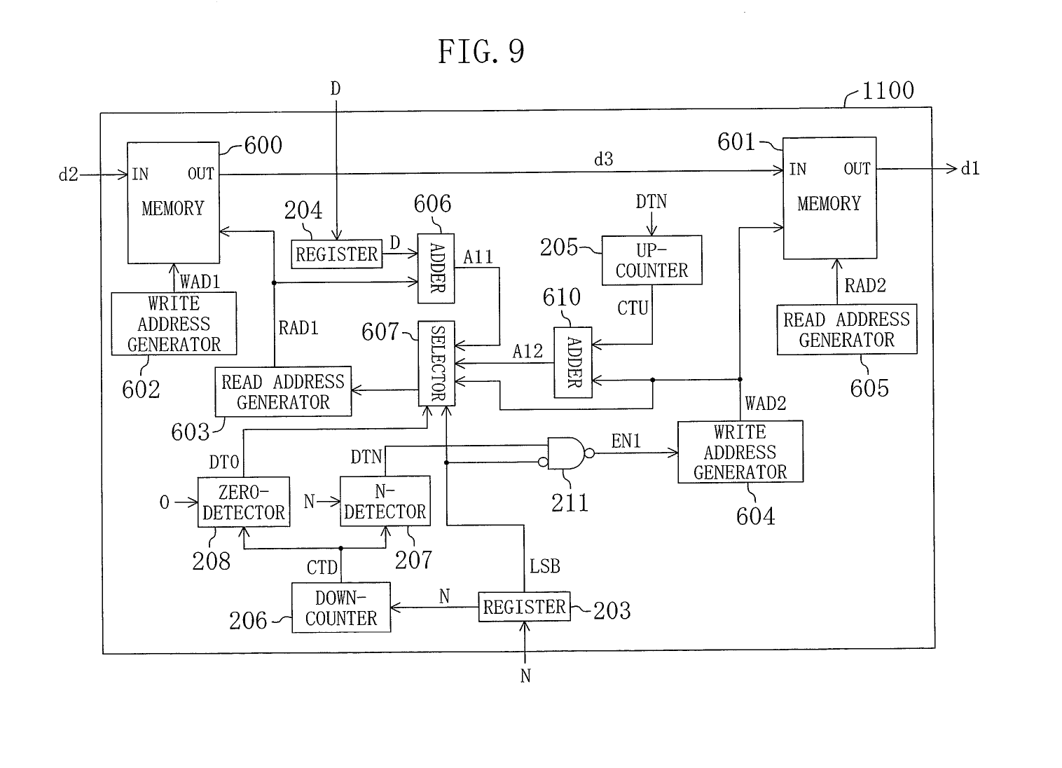

FIG. 9 is a block diagram of the overall structure of a de-interleave circuit according to the second embodiment of the present invention. The de-interleave circuit 1100 of FIG. 9 is a circuit for rearranging the data d2 resulting from the convolutional interleave operation of the interleave circuit 1000 of FIG. 1 back into the original data d1 (i.e., the data before the convolutional interleave operation). The de-interleave circuit 1100 of FIG. 9 realizes the de-interleave operation by switching the read-address generation and control mechanism and the write-address generation and control mechanism of the interleave circuit 1000 of FIG. 1 with each other. The de-interleave circuit 1100 of FIG. 9 includes memories 600, 601, read address generators 603, 605, write address generators 602, 604, a selector 607, registers 203, 204, an up-counter 205, a down-counter 206, an N-detector 207, a zero-detector 208, adders 606, 610, and an enable signal generator 211.

External input data d2 is written to the memory 600 according to a write address WAD1 from the write address generator 602. The input data d2 is the data resulting from the convolutional interleave operation of the interleave circuit 1000 of FIG. 1. The data written to the memory 600 is read according to a read address RAD1 from the read address generator 603. The data d3 thus read from the memory 600 is written to the memory 601 according to a write address WAD2 from the write address generator 604. The data written to the memory 601 is read according to a read address RAD2 from the read address generator 605. The data d1 thus read from the memory 601 is output to the outside.

The register 203 stores the frame length N applied from the outside. The frame length N indicates the number of data included in each frame of the original data d1 (i.e., the data before the convolutional interleave operation of the interleave circuit 1000 of FIG. 1). The register 204 stores the interleave depth D applied from the outside.

The write address generator 602 outputs a write address WAD1. The write address generator 602 increments the write address WAD1 by 1 in response to every write access to the memory 600. It is herein assumed that the initial value of the write address WAD1 is zero.

The adder 610 adds the count value CTU of the up-counter 205 and the write address WAD2 from the write address generator 604. The adder 606 adds the interleave depth D stored in the register 204 and the read address RAD1 from the read address generator 603.

In response to the detection signal DT0 from the zero-detector 208 and the least significant bit LSB of the frame length N stored in the register 203, the selector 607 selects one of the output A11 of the adder 606, the output A12 of the adder 610 and the write address WAD2 for output. More specifically, when the detection signal DT0 from the zero-detector 208 is inactive, the selector 607 selects the output All of the adder 606 for output. When the detection signal DT0 from the zero-detector 208 is active and the least significant bit LSB of the frame length N is zero, the selector 607 selects the output A12 of the adder 610 for output. When the detection signal DT0 from the zero-detector 208 is active and the least significant bit LSB of the frame length N is 1, the selector 607 selects the write address WAD2 for output.

The read address generator 603 outputs the output of the selector 607 as read address RAD1. It is herein assumed that the initial value of the read address RAD1 is zero. The read address RAD1 is incremented by +D in response to every read access to the memory 600.

The write address generator 604 outputs a write address WAD2. When the enable signal EN1 from the enable signal generator 211 is active, the write address generator 604 increments the write address WAD2 by 1 in response to every write access to the memory 601. When the enable signal EN1 is inactive, the write address generator 604 does not increment the write address WAD2. It is herein assumed that the initial value of the write address WAD2 is zero.

The read address generator 605 outputs a read address RAD2. The read address generator 605 increments the read address RAD2 by 1 in response to every read access to the memory 601. It is herein assumed that the initial value of the read address RAD2 is zero.

[Operation of De-Interleave Operation]

Hereinafter, operation of the de-interleave circuit 1100 thus structured will be described.

Input data d2 is applied from the outside to the de-interleave circuit 1100. The input data d2 is the data resulting from the convolutional interleave operation of the interleave circuit 1000 of FIG. 1. The input data d2 is sequentially written to the memory 600 on a byte-by-byte basis according to the write address WAD1 from the write address generator 602. The frame length N of the data d1, i.e., the input data d2 before the convolutional interleave operation of the interleave circuit 1000, is applied to the register 203, and the interleave depth D is applied to the register 204. The interleave depth D is herein set to 2ⁿ (where n is a positive integer). Hereinafter, description will be given for the cases where the frame length N of the data d1 is an even number and an odd number.

(a) When the Frame Length N is an Even Number

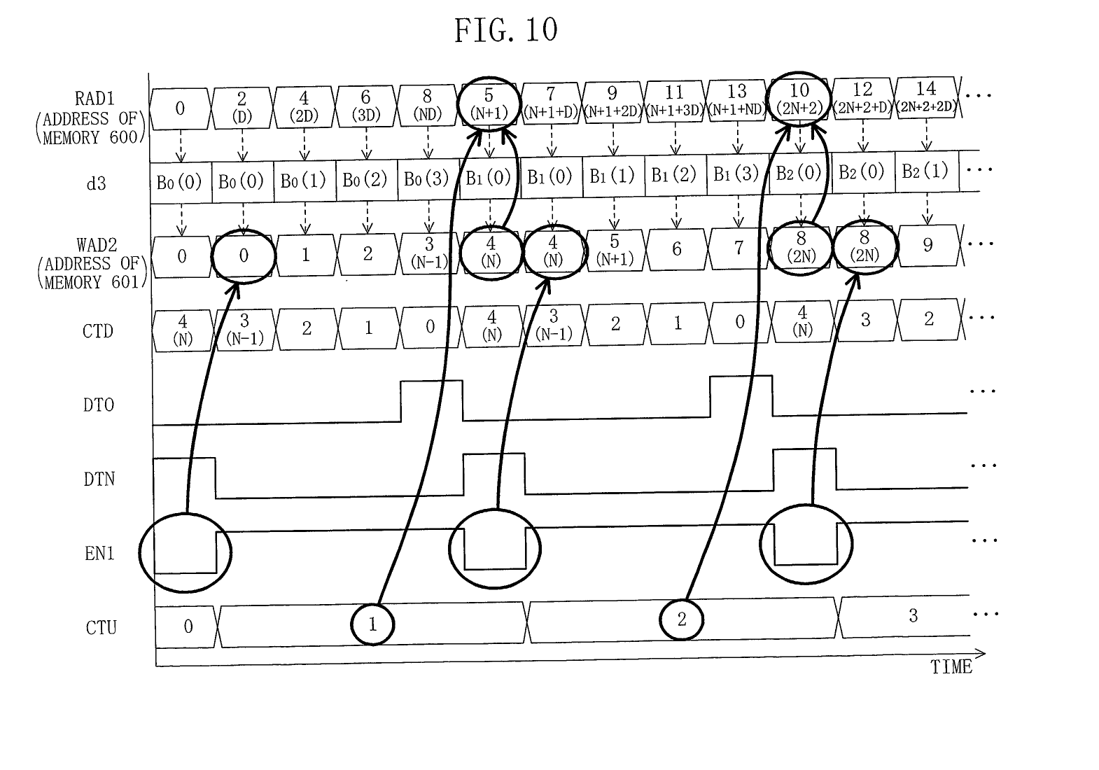

Hereinafter, description will be given with reference to FIG. 10. It is herein assumed that the frame length N is 4 and the interleave depth D is 2.

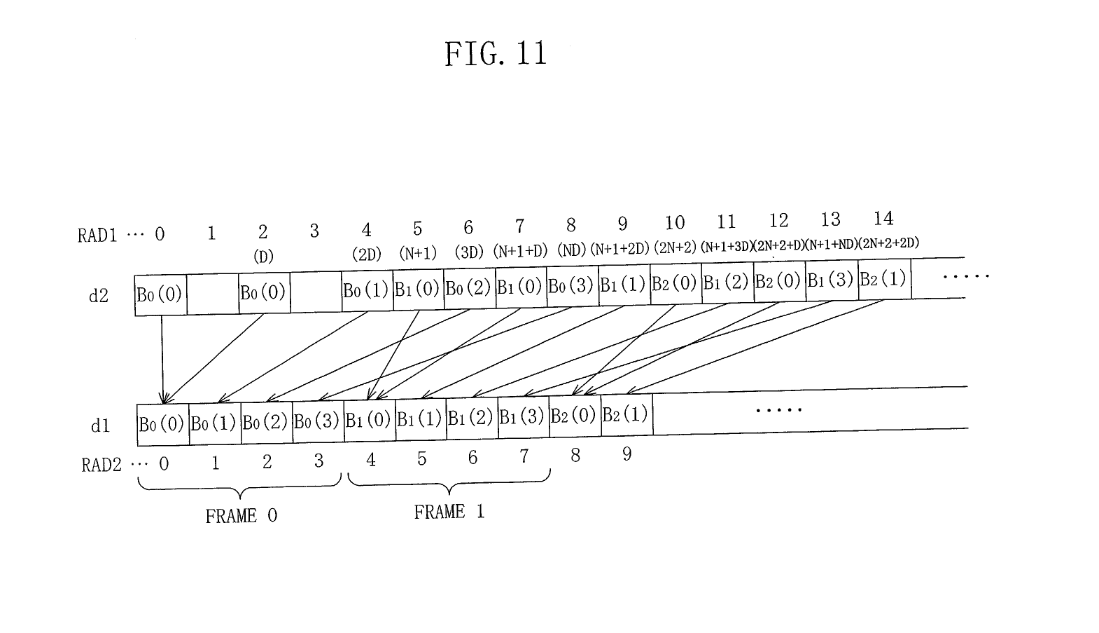

As shown in FIG. 11, the data d2 is stored in the memory 600 on a byte-by-byte basis. More specifically, byte data B₀(0) of frame 0 is stored at address 0 of the memory 600, byte data B₀(0) of frame 0 is stored at address 2 (=D) thereof, byte data B₀(1) of frame 0 is stored at address 4(=2D) thereof, byte data B₁(0) of frame 1 is stored at address 5 (=N+1), and the like.

The initial value “0” of the read address RAD1 is applied from the read address generator 603 to the memory 600. In response to this, byte data B₀(0) is read from address 0 of the memory 600. The initial value “0” of the write address WAD2 is then applied from the write address generator 604 to the memory 601. In response to this, the byte data B₀(0) read from the memory 600 is written to address 0 of the memory 601. Since the frame length N −4) is an even number, the initial value of the output CTD of the down-counter 206 is set to 4 (=N). Since the output CTD of the down-counter 206 is 4 (=N), the output DTN of the N-detector 207 goes to logical high level. The least significant bit LSB of the frame length N (=4) is zero. Accordingly, the enable signal EN1 goes to logical low level. In response to the logical low level enable signal EN1, the write address generator 604 stops updating (incrementing) the write address WAD2.

Since the detection signal DT0 from the zero-detector 208 is at logical low level, the selector 607 selects the output A11 of the adder 606 for output. Accordingly, the read address generator 603 applies the read address RAD1 incremented by the interleave depth D (=2) to the memory 600. More specifically, address 2 (=D) is applied to the memory 600 as read address RAD1. In response to this, byte data B₀(0) is read from address 2 (=D) of the memory 600. Since the write address generator 604 stops updating the write address WAD2, the initial value “0” of the write address WAD2 is again applied to the memory 601. In response to this, the byte data B₀(0) read from the memory 600 is again written to address 0 of the memory 601. The output CTD of the down-counter 206 becomes 3 (=N−1). In response to this, the output DTN of the N-detector 207 goes to logical low level, and the enable signal EN1 goes to logical high level. In response to the logical high level enable signal EN1, the write address generator 604 increments the write address WAD2 by 1.

The read address RAD1 incremented by the interleave depth D (=2), i.e., address 4 (=2D), is applied from the read address generator 603 to the memory 600. In response to this, byte data B₀(1) is read from address 4 (=2D) of the memory 600. Address 1 is applied to the memory 601 as write address WAD2. In response to this, the byte data B₀(1) read from the memory 600 is written to address 1 of the memory 601. The output CTD of the down-counter 206 becomes 2. The enable signal EN1 remains at logical high level. In response to the logical high level enable signal EN1, the write address generator 604 increments the write address WAD2 by 1.

The read address RAD1 incremented by the interleave depth D (=2), that is, address 6 (=3D), is applied from the read address generator 603 to the memory 600. In response to this, byte data B₀(2) is read from address 6 (=3D) of the memory 600. Address 2 is applied to the memory 601 as write address WAD2. In response to this, the byte data B₀(2) read from the memory 600 is written to address 2 of the memory 601. The output CTD of the down-counter 206 becomes 1. The enable signal EN1 remains at logical high level. In response to the logical high level enable signal EN1, the write address generator 604 increments the write address WAD2 by 1.

The read address RAD1 incremented by the interleave depth D (=2), i.e., address 8 (=ND), is applied from the read address generator 603 to the memory 600. In response to this, byte data B₀(3) is read from address 8 (=ND) of the memory 600. Address 3 (=N−1) is applied to the memory 601 as write address WAD2. In response to this, the byte data B₀(3) read from the memory 600 is written to address 3 (=N−1) of the memory 601. The output CTD of the down-counter 206 becomes zero. The enable signal EN1 remains at logical high level. In response to the logical high level enable signal EN1, the write address generator 604 increments the write address WAD2 by 1.

Since the output CTD of the down-counter 206 becomes zero, the output DT0 of the zero-detector 208 responsively goes to logical high level. The least significant bit LSB of the frame length N is zero. Therefore, the selector 607 selects the output A12 of the adder 610 for output. The sum of the write address WAD2 (=4=N) and the output CTU (=1) of the up-counter 205 (i.e., 5=N+1) is thus applied from the read address generator 603 to the memory 600 as read address RAD1. In response to this, byte data B₁(0) is read from address 5 (=N+1) of the memory 600. Address 4 (=N) is applied to the memory 601 as write address WAD2. In response to this, the byte data B₁(00) read from the memory 600 is written to address 4 (=N) of the memory 601. The output CTD of the down-counter 206 is reset to the initial value “4” (=N). Thereafter, the same process as that described above is repeated.

The byte data stored in the memory 601 is read according to the read address RAD2 from the read address generator 605. More specifically, the byte data is sequentially read from address 0, address 1, address 2, address 3, and the like of the memory 601. The data thus read from the memory 601 is output to the outside as output data d1. As shown in FIG. 11, by the de-interleave operation of the de-interleave circuit 1100, the byte data arrangement of the input data d2 is restored to the original arrangement (i.e., the arrangement before the interleave operation of the interleave circuit 1000 of FIG. 1).

(b) When the Frame Length N is an Odd Number

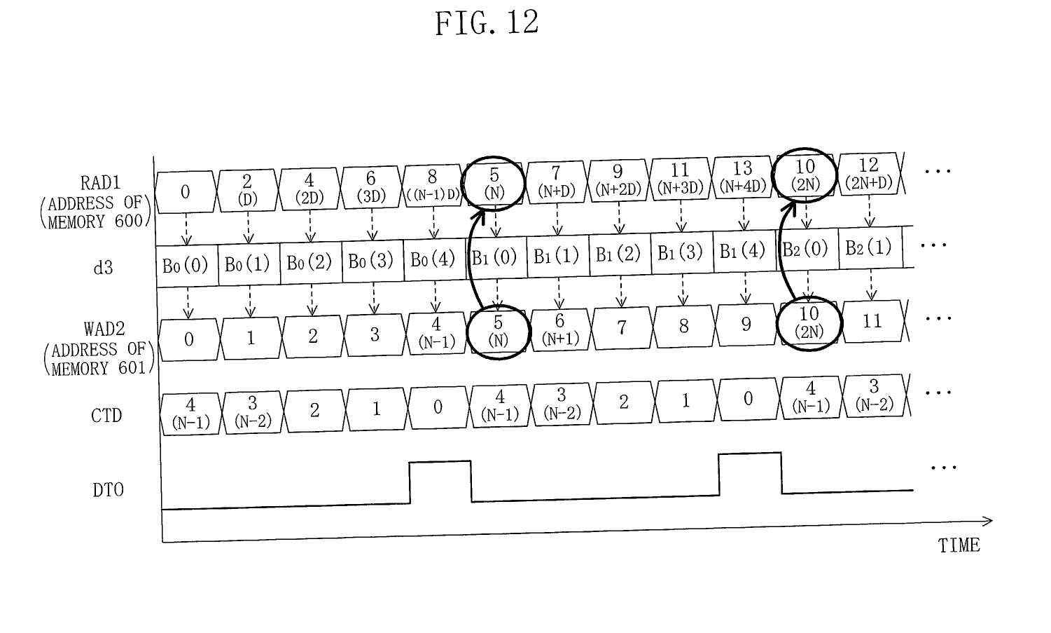

Description will now be given with reference to FIG. 12. It is herein assumed that the frame length N is 5 and the interleave depth D is 2.

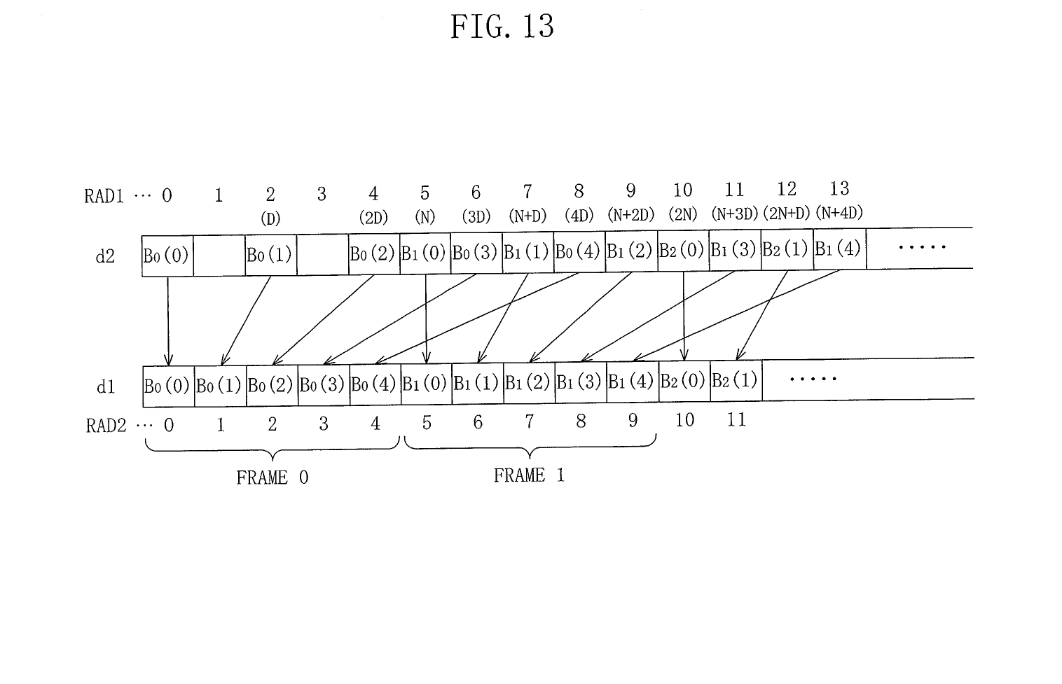

As shown in FIG. 13, the data d2 is stored in the memory 600 on a byte-by-byte basis. More specifically, byte data B₀(0) of frame 0 is stored at address 0 of the memory 600, byte data B₀(1) of frame 0 is stored at 2 (=D) thereof, byte data B₀(2) of frame 0 is stored at address 4 (=2D) thereof, byte data B₁(0) of frame I is stored at address 5 (=N) thereof, and the like.

The initial value “0” of the read address RAD1 is applied from the read address generator 603 to the memory 600. In response to this, byte data B₀(0) is read from address 0 of the memory 600. The initial value “0” of the write address WAD2 is applied from the write address generator 604 to the memory 601. In response to this, the byte data B₀(0) read from the memory 600 is written to address 0 of the memory 601. Since the frame length N (=5) is an odd number, the initial value of the output CTD of the down-counter 206 is set to 4 (=N−1). The least significant bit LSB of the frame length N (=5) is 1. Accordingly, the enable signal EN1 is always at logical high level. In response to the logical high level enable signal EN1, the write address generator 604 increments the write address WAD2 by 1.

Since the detection signal DT0 from the zero-detector 208 is at logical low level, the selector 607 selects the output A11 of the adder 606 for output. Accordingly, the read address RAD1 incremented by the interleave depth D (=2), that is, address 2 (=D), is applied from the read address generator 603 to the memory 600. In response to this, byte data B₀(1) is read from address 2 (=D) of the memory 600. Address 1 is applied to the memory 601 as write address WAD2. In response to this, the byte data B₀(1) read from the memory 600 is written to address 1 of the memory 601.

According to the same transfer process as that of the byte data B₀(1), byte data B₀(2), B₀(3) and B₀(4) stored in addresses 4 (=2D), 6 (=3D) and 8 (=4D) of the memory 600 are written to addresses 2, 3 and 4 of the memory 601, respectively.

Once N (=5) byte data B₀(0) to B₀(4) are transferred from the memory 600 to the memory 601, the output CDT of the down-counter 206 becomes zero, and the detection signal DT0 goes to logical high level. Since the enable signal EN1 remains at logical high level, the write address generator 604 increments the write address WAD2 by 1. Since the detection signal DT0 is at logical high level and the least significant bit LSB of the frame length N is 1, the selector 607 selects the write address WAD2 for output. The write address WAD2 (=5=N) is thus applied from the read address generator 603 to the memory 600 as read address RAD1. In response to this, byte data B₁(0) is read from address 5 (=N) of the memory 600. Address 5 (=N) is applied to the memory 601 as write address WAD2. In response to this, the byte data B₁(0) read from the memory 600 is written to address 5 (=N) of the memory 601. The output CTD of the down-counter 206 is reset to the initial value “4” (=N−1). Thereafter, the same process as that described above is repeated.

The byte data stored in the memory 601 is read according to the read address RAD2 from the read address generator 605. More specifically, byte data is sequentially read from address 0, address 1, address 2, address 3, and the like of the memory 601. The data thus read from the memory 601 is output to the outside as output data d1. As shown in FIG. 13, by the de-interleave operation of the de-interleave circuit 1100, the byte data arrangement of the input data d2 is restored to the original arrangement (i.e., the arrangement before the interleave operation of the interleave circuit 1000 of FIG. 1)

[Effects]

As has been described above, the de-interleave circuit of the second embodiment realizes the de-interleave operation by switching the read-address generation and control mechanism and the write-address generation and control mechanism of the interleave circuit 1000 of FIG. 1 with each other. When the frame length N is an even number, the head byte data in each frame of the data d1 is written to the same address of the memory 601 twice in succession. This enables the byte data inserted as a dummy byte by the interleave circuit 1000 of FIG. 1 to be removed. As a result, the data d2 resulting from the convolutional interleave operation of the interleave circuit 1000 of FIG. 1 can be restored to the original data d1 (i.e., the data before the convolutional interleave operation).

[Modification]

Note that the above description is given for the case where the frame length N of the data d1 is 4 and 5. However, the de-interleave operation can be conducted in the same manner as that described above even when the input data d1 has another frame length N.

Moreover, the above description is given for the case where the interleave depth D is 2. However, the de-interleave operation can be conducted in the same manner as that described above even when the interleave depth D has another value (where D is 2ⁿ (n is a positive integer)).

(Third Embodiment)

[Structure of Interleave Circuit]

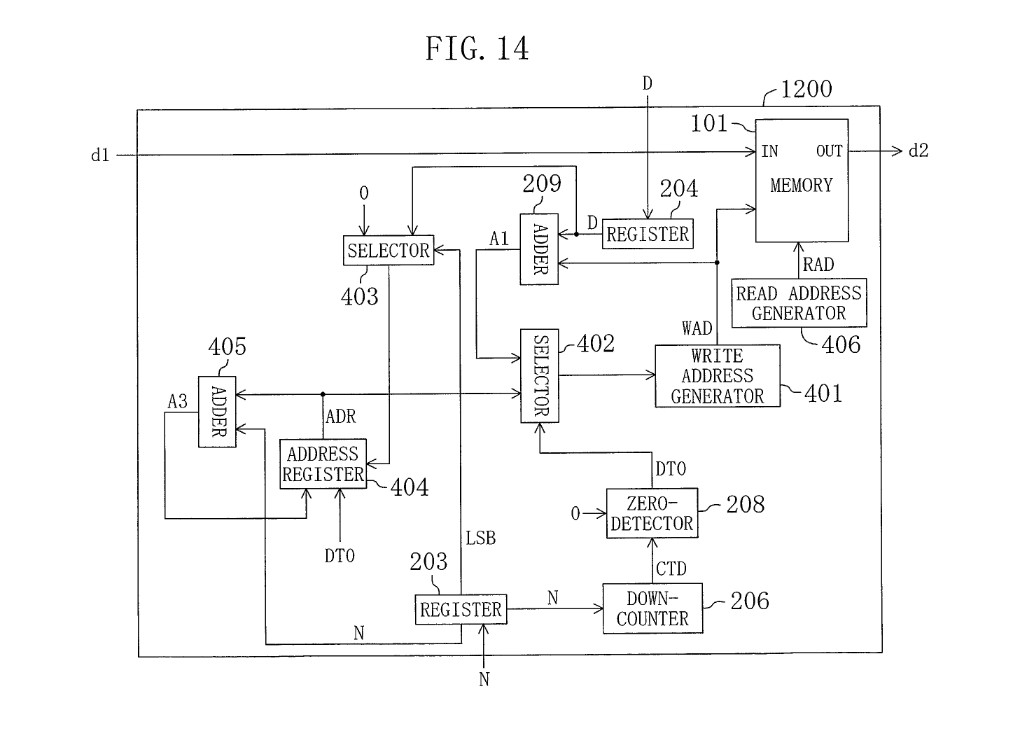

FIG. 14 is a block diagram of the overall structure of an interleave circuit according to the third embodiment of the present invention. The interleave circuit 1200 of FIG. 14 is a convolutional interleave circuit for continuously rearranging input data d1 regardless of the frame structure and outputting the resultant data as output data d2. The interleave circuit 1200 of FIG. 14 includes a memory 101, registers 203, 204, a down-counter 206, a zero-detector 208, adders 209, 405, a write address generator 401, selectors 402, 403, an address register 404, and a read address generator 406.

The interleave circuit 1000 of FIG. 1 first accumulates the input data d1 in the memory 100 and then write it to the memory 101. In contrast, the interleave circuit 1200 of FIG. 14 does not include the memory 100, and writes the input data d1 directly to the memory 101. In other words, the external input data d1 is written to the memory 101 according to a write address WAD from the write address generator 401. The data written to the memory 101 is read according to a read address RAD from the read address generator 406. The data d2 thus read from the memory 101 is output to the outside.

The down-counter 206 decrements the frame length N stored in the register 203 minus 1 (i.e., N−1) by 1 in response to every write access to the memory 101. The initial value of the count value CTD of the down-counter 206 is herein set to zero.

The selector 403 selects either zero or the interleave depth D according to the least significant bit LSB of the frame length N for output. More specifically, when the least significant bit of the frame length N is 1 (when the frame length N is an odd number), the selector 403 outputs “zero”. When the least significant bit LBS of the frame length N is zero (when the frame length N is an even number), the selector 403 outputs the interleave depth D. The output of the selector 403 is set to the address register 404 as an initial value of the address ADR.

The adder 405 adds the frame length N having its least significant bit replaced with 1 and the output ADR of the address register 404.

The address register 404 stores the output A3 of the adder 405 as address ADR in response to an active detection signal DT0 from the zero-detector 208. In other words, the address register 404 updates the address ADR every time the output CTD of the down-counter 206 becomes zero. The updated value is the sum of the frame length having its least significant bit replaced with 1 and the output ADR of the address register 404 before update.

The selector 402 selects either the output A1 of the adder 209 or the output ADR of the address register 404 for output according to the detection signal DT0 from the zero-detector 208. More specifically, the selector 402 selects the output ADR of the address register 404 in response to an active detection signal DT0, and selects the output A1 of the adder 209 in response to an inactive detection signal DT0.

The write address generator 401 outputs the output of the selector 402 as write address WAD.

The read address generator 406 outputs a read address RAD. The read address generator 406 increments the read address RAD by 1 in response to every read access to the memory 101. The initial value of the read address RAD is herein set to zero.

[Operation of Interleave Circuit]

Hereinafter, operation of the interleave circuit 1200 thus structured will be described.

Input data d1 is applied from the outside to the interleave circuit 1200. As shown in FIG. 2, the input data d1 is a data string including a plurality of frames. Each frame includes N byte data B(0) to B(N−1). Accordingly, the number of data included in each frame of the input data d1, that is, the frame length of the input data d1, is N. The input data d1 is sequentially applied in the following order: byte data B₀(0), B₀(1), . . . , B₀(N−1) of frame 0, byte data B₁(0), B₁(1), . . . , B₁(N−1) of frame 1, byte data B₂(0), B₂(1), . . . , B₂(N−1) of frame 2 and the like. The frame length N of the input data d1 is applied to the register 203, and the interleave depth D is applied to the register 204. The interleave depth D is herein set to 2ⁿ (where n is a positive integer). Hereinafter, description will be given for the cases where the frame length N of the input data d1 is an even number and an odd number.

(a) When the Frame Length N is an Even Number

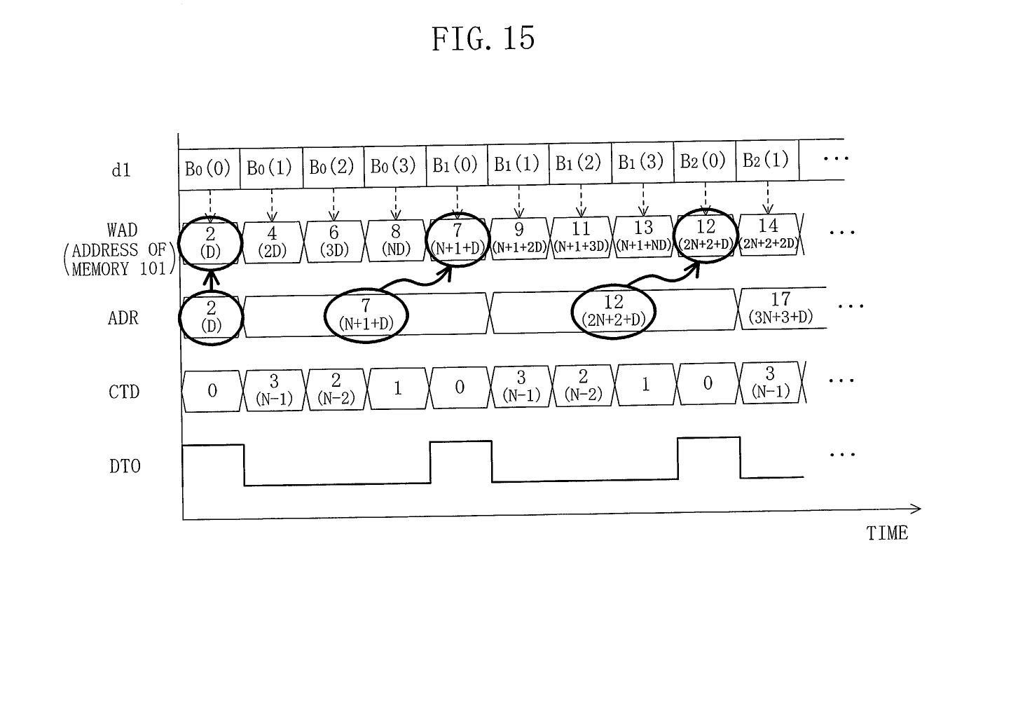

Hereinafter, description will be given with reference to FIG. 15. It is herein assumed that the frame length N is 4 and the interleave depth D is 2.

Since the least significant bit LSB of the frame length N is zero, the selector 403 outputs the interleave depth D (=2). The output D (=2) of the selector 403 is set to the address register 404 as the initial value of the address ADR. Since the output CDT of the down-counter 206 is zero (initial value), the detection signal DT0 from the zero-detector 208 is at logical high level. In response to the logical high level detection signal DT0, the selector 402 selects the output ADR (=2=D) of the address register 404. Address 2 (=D) is thus applied from the write address generator 401 to the memory 101 as write address WAD. In response to this, byte data B₀(0) is written to address 2 (=D) of the memory 101.

The output CTD of the down-counter 206 becomes 3 (=N−1). In response to this, the detection signal DT0 from the zero-detector 208 goes to logical low level. In response to this, the address register 404 updates the address ADR to the output A3 (7=(N+1)+D) of the adder 405. In response to the logical low level detection signal DT0, the selector 402 selects the output A1 (4=2D=D+D) of the adder 209. Address 4 (=2D) is thus applied from the write address generator 401 to the memory 101 as write address. In response to this, byte data B₀(1) is written to address 4 (=2D) of the memory 101.

The output CTD of the down-counter 206 becomes 2 (=N−2). The detection signal DT0 from the zero-detector 208 remains at logical low level. In response to the logical low level detection signal DT0, the selector 402 selects the output A1 (6=2D+D) of the adder 209. Address 6 (=3D) is thus applied from the write address generator 401 to the memory 101 as write address. In response to this, byte data B₀(2) is written to address 6 (=3D) of the memory 101.

The output CTD of the down-counter 206 becomes 1. The detection signal DT0 from the zero-detector 208 remains at logical low level. In response to the logical low level detection signal DT0, the selector 402 selects the output A1 (8=3D+D=ND) of the adder 209. Address 8 (=ND) is thus applied from the write address generator 401 to the memory 101 as write address. In response to this, byte data B₀(3) is written to address 8 (=ND) of the memory 101.

The output CTD of the down-counter 206 becomes zero. In response to this, the detection signal DT0 from the zero-detector 208 goes to logical high level. In response to the logical high level detection signal DT0, the selector 402 selects the output ADR (7=(N+1)+D) of the address register 404. Address 7 (=N+1+D) is thus applied from the write address generator 401 to the memory 101 as write address WAD. In response to this, byte data B₁(0) is written to address 7 (=N+1+D) of the memory 101.

The output CTD of the down-counter 206 becomes 3 (=N 1). In response to this, the detection signal DT0 from the zero-detector 208 goes to logical low level. In response to this, the address register 404 updates the address ADR to the output A3 (12=(N+1)+(N+1+D)=2N+2+D) of the adder 405. In response to the logical low level detection signal DT0, the selector 402 selects the output A1 (9=(N+1+D)+D) of the adder 209. Address 9 (=N+1+2D) is thus applied from the write address generator 401 to the memory 101 as write address. In response to this, byte data B₁(1) is written to address 9 (=N+1+2D) of the memory 101. Thereafter, the same process as that described above is repeated.

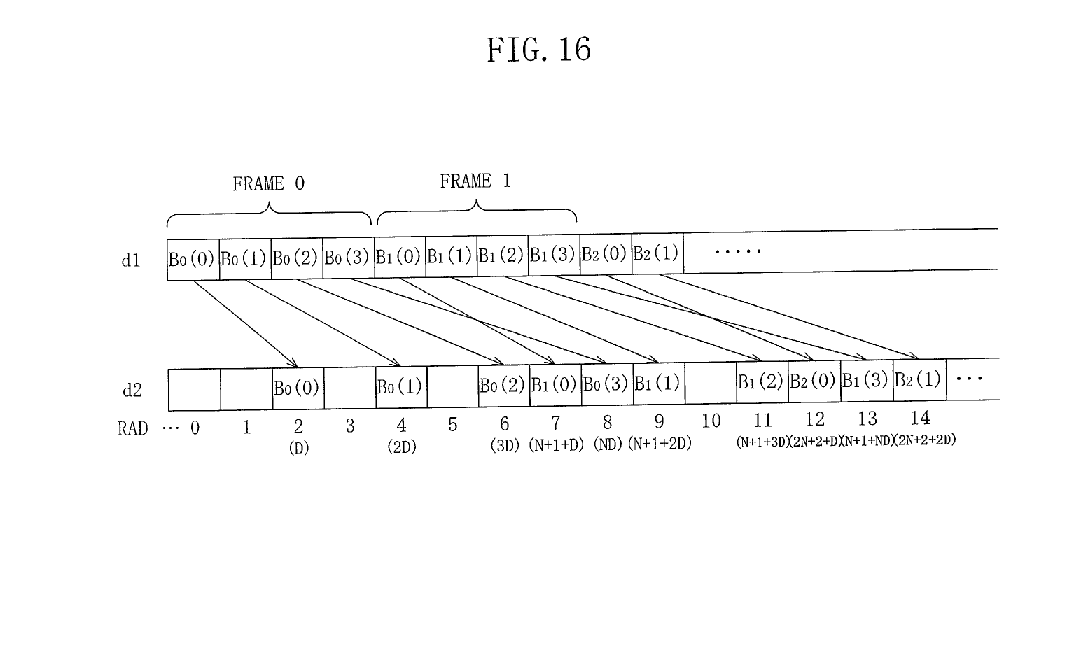

The byte data stored in the memory 101 is read according to the read address RAD from the read address generator 406. More specifically, the byte data is sequentially read from address 0, address 1, address 2, address 3, and the like of the memory 101. The data thus read from the memory 101 is output to the outside as output data d2. As shown in FIG. 16, the input data d2 is rearranged into output data d2 by the interleave operation of the interleave circuit 1200.

(b) When the Frame Length N is an Odd Number

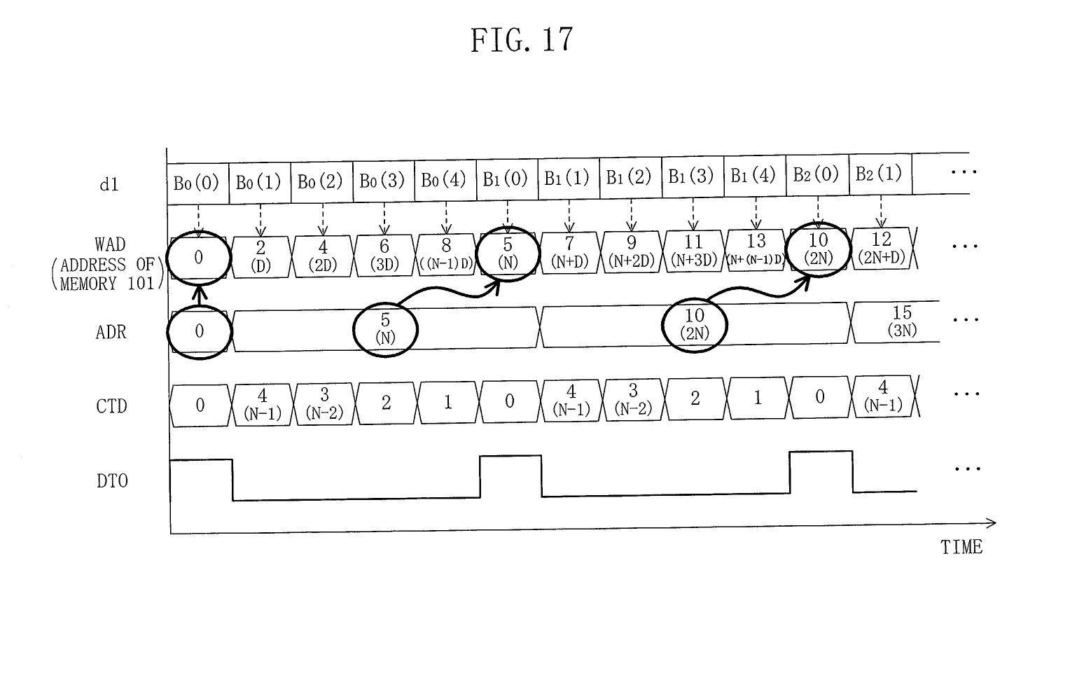

Description will now be given with reference to FIG. 17. It is herein assumed that the frame length N is 5 and the interleave depth D is 2.

Since the least significant bit LSB of the frame length N is 1, the selector 403 outputs zero. The output “0” of the selector 403 is set to the address register 404 as the initial value of the address ADR. Since the output CDT of the down-counter 206 is zero (initial value), the detection signal DT0 from the zero-detector 208 is at logical high level. In response to the logical high level detection signal DT0, the selector 402 selects the output ADR (=0) of the address register 404. Address 0 is thus applied from the write address generator 401 to the memory 101 as write address WAD. In response to this, byte data B₀(0) is written to address 0 of the memory 101.

The output CTD of the down-counter 206 becomes 4 (=N−1). In response to this, the detection signal DT0 from the zero-detector 208 goes to logical low level. In response to this, the address register 404 updates the address ADR to the output A3 (5=N+0) of the adder 405. In response to the logical low level detection signal DT0, the selector 402 selects the output A1 (2=D+0) of the adder 209. Address 2 (=D) is thus applied from the write address generator 401 to the memory 101 as write address. In response to this, byte data B₀(1) is written to address 2 (=D) of the memory 101.

The output CTD of the down-counter 206 becomes 3 (=N−2). The detection signal DT0 from the zero-detector 208 remains at logical low level. In response to the logical low level detection signal DT0, the selector 402 selects the output A1 (4=D+D) of the adder 209. Address 4 (=2D) is thus applied from the write address generator 401 to the memory 101 as write address. In response to this, byte data B₀(2) is written to address 4 (=2D) of the memory 101.

The output CTD of the down-counter 206 becomes 2. The detection signal DT0 from the zero-detector 208 remains at logical low level. In response to the logical low level detection signal DT0, the selector 402 selects the output A1 (6=2D+D) of the adder 209. Address 6 (=3D) is thus applied from the write address generator 401 to the memory 101 as write address. In response to this, byte data B₀(3) is written to address 6 (=3D) of the memory 101.

The output CTD of the down-counter 206 becomes 1. The detection signal DT0 from the zero-detector 208 remains at logical low level. In response to the logical low level detection signal DT0, the selector 402 selects the output A1 (8=3D+D=(N−1)D) of the adder 209. Address 8 (=(N−1)D) is thus applied from the write address generator 401 to the memory 101 as write address. In response to this, byte data B₀(4) is written to address 8 (=(N−1)D) of the memory 101.

The output CTD of the down-counter 206 becomes zero. In response to this, the detection signal DT0 from the zero-detector 208 goes to logical high level. In response to the logical high level detection signal DT0, the selector 402 selects the output ADR (5=N) of the address register 404. Address 5 (=N) is thus applied from the write address generator 401 to the memory 101 as write address WAD. In response to this, byte data B₁(00) is written to address 5 (=N) of the memory 101.

The output CTD of the down-counter 206 becomes 4 (=N−1). In response to this, the detection signal DT0 from the zero-detector 208 goes to logical low level. In response to this, the address register 404 updates the address ADR to the output A3 (10=N+N) of the adder 405. In response to the logical low level detection signal DT0, the selector 402 selects the output A1 (7=N+D) of the adder 209. Address 7 (=N+D) is thus applied from the write address generator 401 to the memory 101 as write address. In response to this, byte data B₁(1) is written to address 7 (=N+D) of the memory 101. Thereafter, the same process as that described above is repeated.

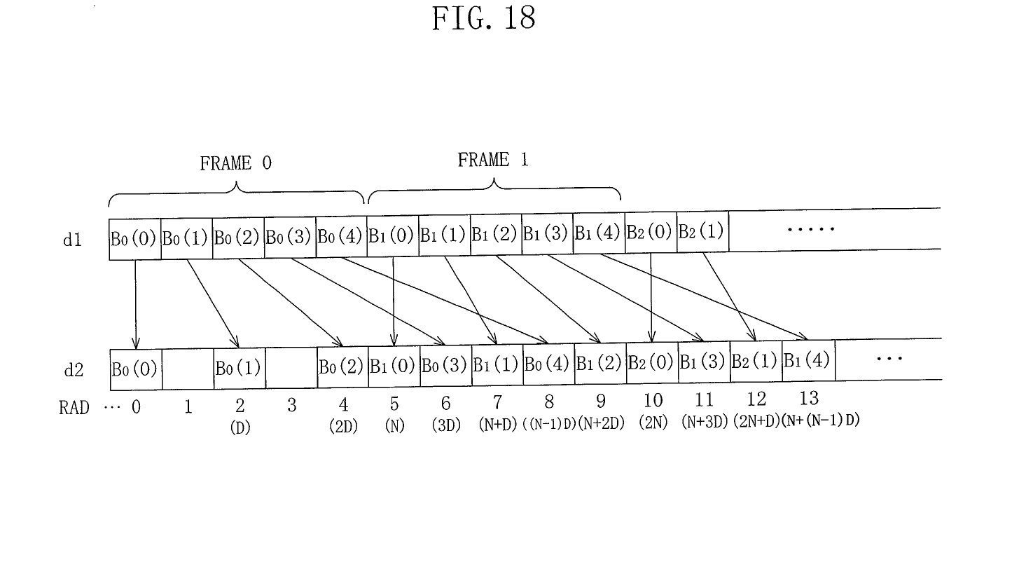

The byte data stored in the memory 101 is read according to the read address RAD from the read address generator 406. More specifically, the byte data are sequentially read from address 0, address 1, address 2, address 3, and the like of the memory 101. The data thus read from the memory 101 is output to the outside as output data d2. As shown in FIG. 18, the input data d1 is rearranged into output data d2 by the interleave operation of the interleave circuit 1200.

[Effects]

As has been described above, the interleave circuit 1200 of the third embodiment is capable of conducting the convolutional interleave operation whether the frame length N of the input data d1 is an even number or an odd number. In other words, the interleave operation according to ITU recommendations G.992.1 and G.992.2 can be conducted whether the frame length N of the input data d1 is an even number or an odd number.

[Modification]

Note that the above description is given for the case where the frame length N of the input data d1 is 4 and 5. However, the interleave operation can be conducted in the same manner as that described above even when the input data d1 has another frame length N.

Moreover, the above description is given for the case where the interleave depth D is 2. However, the interleave operation can be conducted in the same manner as that described above even when the interleave depth D has another value (where D is 2ⁿ (n is a positive integer)).

Another structure is also possible in order to reduce the memory region to be used in the memory 101 as much as possible. More specifically, the write address generator 401 and the read address generator 406 may be structured as follows: If the frame length N is an odd number, the write address WAD and the read address RAD are reset to the initial value “0” when they exceed (frame length N)×(interleave depth D). If the frame length N is an even number, the write address WAD and the read address RAD are reset to the initial value “0” when they exceed (N+1)×D. The memory region to be used in the memory 101 is thus N×D bytes when the frame length N is an odd number, and (N+1)×D bytes when the frame length N is an even number.

The memory 101 may be replaced with a FIFO buffer.

(Fourth Embodiment)

[Structure of De-Interleave Circuit]

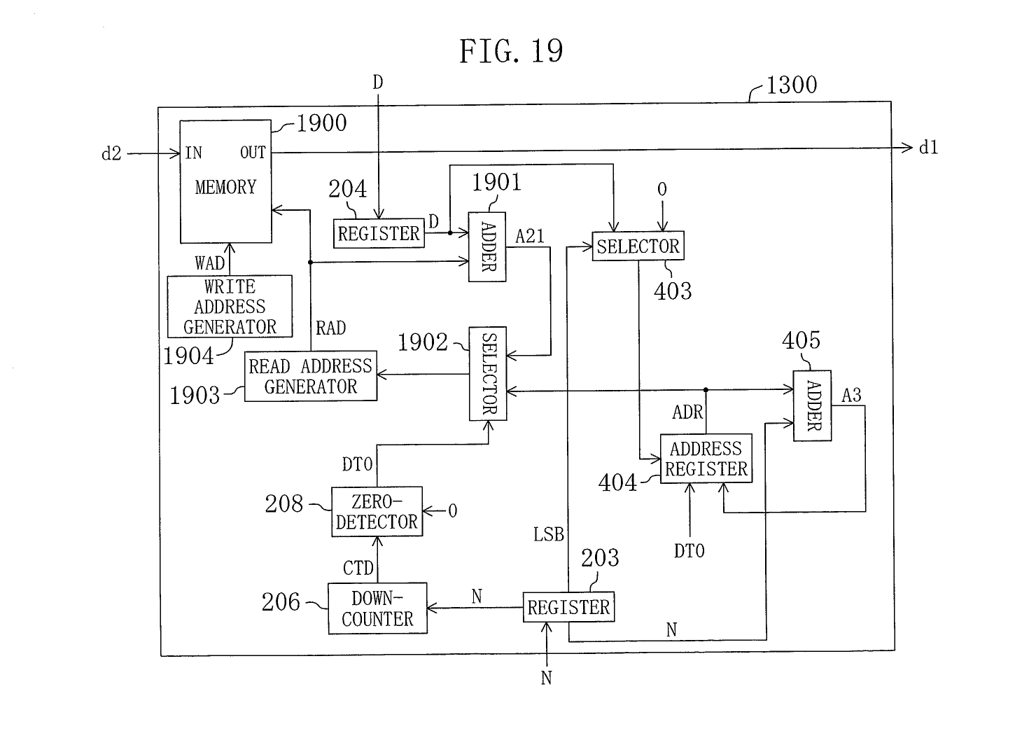

FIG. 19 is a block diagram of the overall structure of a de-interleave circuit according to the fourth embodiment of the present invention. The de-interleave circuit 1300 of FIG. 19 is a circuit for rearranging the data d2 resulting from the convolutional interleave operation of the interleave circuit 1200 of FIG. 14 back into the original data d1 (i.e., the data before the convolutional interleave operation). The de-interleave circuit 1300 of FIG. 19 realizes the de-interleave operation by switching the read-address generation and control mechanism and the write-address generation and control mechanism of the interleave circuit 1200 of FIG. 14 with each other. The de-interleave circuit 1300 of FIG. 19 includes a memory 1900, registers 203, 204, a down-counter 206, a zero-detector 208, adders 405, 1901, a read address generator 1903, selectors 403, 1902, an address register 404, and a write address generator 1904.

External input data d2 is written to the memory 1900 according to a write address WAD from the write address generator 1904. The input data d2 is the data resulting from the convolutional interleave operation of the interleave circuit 1200 of FIG. 14. The data written to the memory 1900 is read according to a read address RAD from the read address generator 1903. The data d1 thus read from the memory 1900 is output to the outside.

The register 203 stores the frame length N applied from the outside. The frame length N indicates the number of data included in each frame of the original data d1 (i.e., the data before the convolutional interleave operation of the interleave circuit 1200 of FIG. 14). The register 204 stores the interleave depth D applied from the outside.

The down-counter 206 decrements the frame length N stored in the register 203 minus 1 (i.e., N−1) by 1 in response to every read access to the memory 1900. The initial value of the count value CTD of the down-counter 206 is herein set to zero.

The adder 1901 adds the interleave depth D stored in the register 204 and the read address RAD from the read address generator 1903.

In response to the detection signal DT0 from the zero-detector 208, the selector 1902 selects either the output A21 of the adder 1901 or the output ADR of the address register 404 for output. More specifically, the selector 1902 selects the output ADR of the address register 404 in response to an active detection signal DT0, and selects the output A21 of the adder 1901 in response to an inactive detection signal DT0.

The read address generator 1903 outputs the output of the selector 1902 as read address RAD.

The write address generator 1904 outputs a write address WAD. The write address generator 1904 increments the write address WAD by 1 in response to every write access to the memory 1900. The initial value of the write address WAD is herein set to zero.

[Operation of De-interleave Operation]

Hereinafter, operation of the de-interleave circuit 1300 thus structured will be described.

Input data d2 is applied from the outside to the de-interleave circuit 1300. The input data d2 is the data resulting from the convolutional interleave operation of the interleave circuit 1200 of FIG. 14. The input data d2 is sequentially written to the memory 1900 on a byte-by-byte basis according to the write address WAD from the write address generator 1904. The frame length N of the original data d1, that is, the input data d2 before the convolutional interleave operation of the interleave circuit 1200 of FIG. 14, is applied to the register 203, and the interleave depth D is applied to the register 204. The interleave depth D is herein set to 2ⁿ (where n is a positive integer).

Hereinafter, description will be given for the cases where the frame length N of the data d1 is an even number and an odd number.

(a) When the Frame Length N is an Even Number

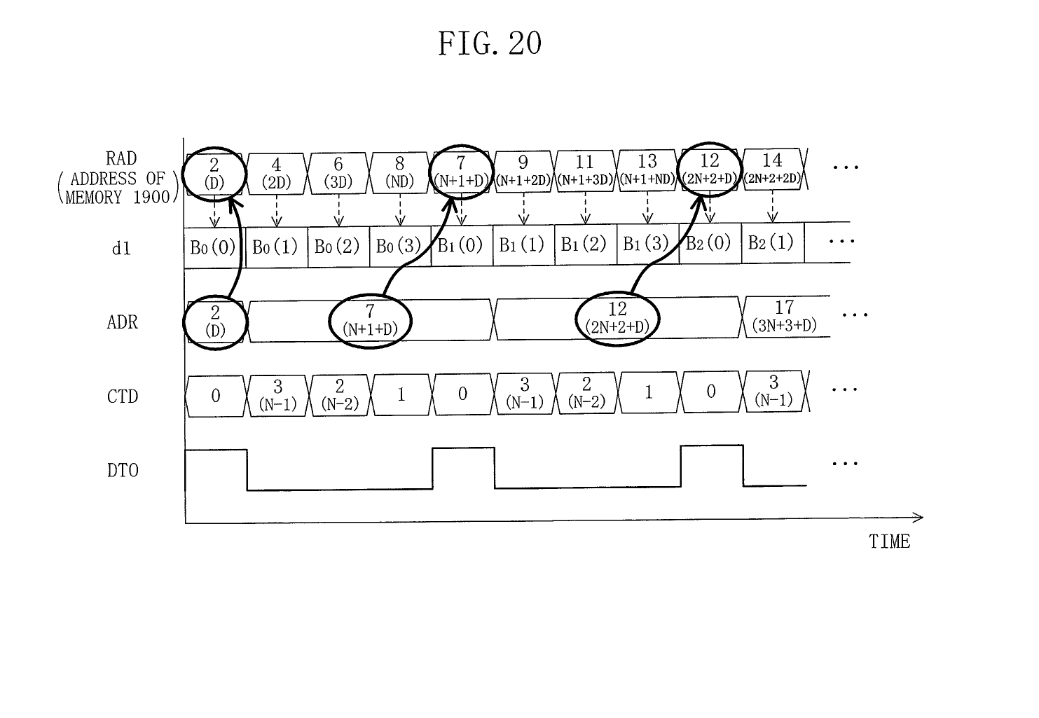

Hereinafter, description will be given with reference to FIG. 20. It is herein assumed that the frame length N is 4 and the interleave depth D is 2.

As shown in FIG. 16, the data d2 is sequentially stored in the memory 1900 on a byte-by-byte basis.

Since the least significant bit LSB of the frame length N is zero, the selector 403 outputs the interleave depth D (=2). The output D (=2) of the selector 403 is set to the address register 404 as the initial value of the address ADR. Since the output CDT of the down-counter 206 is zero (initial value), the detection signal DT0 from the zero-detector 208 is at logical high level. In response to the logical high level detection signal DT0, the selector 1902 selects the output ADR (=2=D) of the address register 404. Address 2 (=D) is thus applied from the read address generator 1903 to the memory 1900 as read address RAD. In response to this, byte data B₀(0) is read from address 2 (=D) of the memory 1900.

The output CTD of the down-counter 206 becomes 3 (=N−1). In response to this, the detection signal DT0 from the zero-detector 208 goes to logical low level. In response to this, the address register 404 updates the address ADR to the output A3 (7=N+1+D) of the adder 405. In response to the logical low level detection signal DT0, the selector 1902 selects the output A21 (4=2D=D+D) of the adder 1901. Address 4 (=2D) is thus applied from the read address generator 1903 to the memory 1900 as read address. In response to this, byte data B₀(1) is read from address 4 (=2D) of the memory 1900.

Byte data B₀(2), B₀(3) are respectively read from addresses 6 (=3D), 8 (=ND) of the memory 1900 in the same manner as that of the byte data B₀(1).

The output CTD of the down-counter 206 becomes zero. In response to this, the detection signal DT0 from the zero-detector 208 goes to logical high level. In response to the logical high level detection signal DT0, the selector 1902 selects the output ADR (7=(N+1)+D) of the address register 404. Address 7 (=N+1+D) is thus applied from the read address generator 1903 to the memory 1900 as read address RAD. In response to this, the byte data B₁(0) is read from address 7 (=N+1+D) of the memory 1900.

The output CTD of the down-counter 206 becomes 3 (=N−1). In response to this, the detection signal DT0 from the zero-detector 208 goes to logical low level. In response to this, the address register 404 updates the address ADR to the output A3 (12=(N+1)+(N+1+D)=2N+2+D) of the adder 405. In response to the logical low level detection signal DT0, the selector 1902 selects the output A21 (9=(N +1+D)+D) of the adder 1901. Address 9 (=N+1+2D) is thus applied from the read address generator 1903 to the memory 1900 as read address. In response to this, byte data B₁(1) is read from address 9 (=N+1+2D) of the memory 1900. Thereafter, the same process as that described above is repeated.

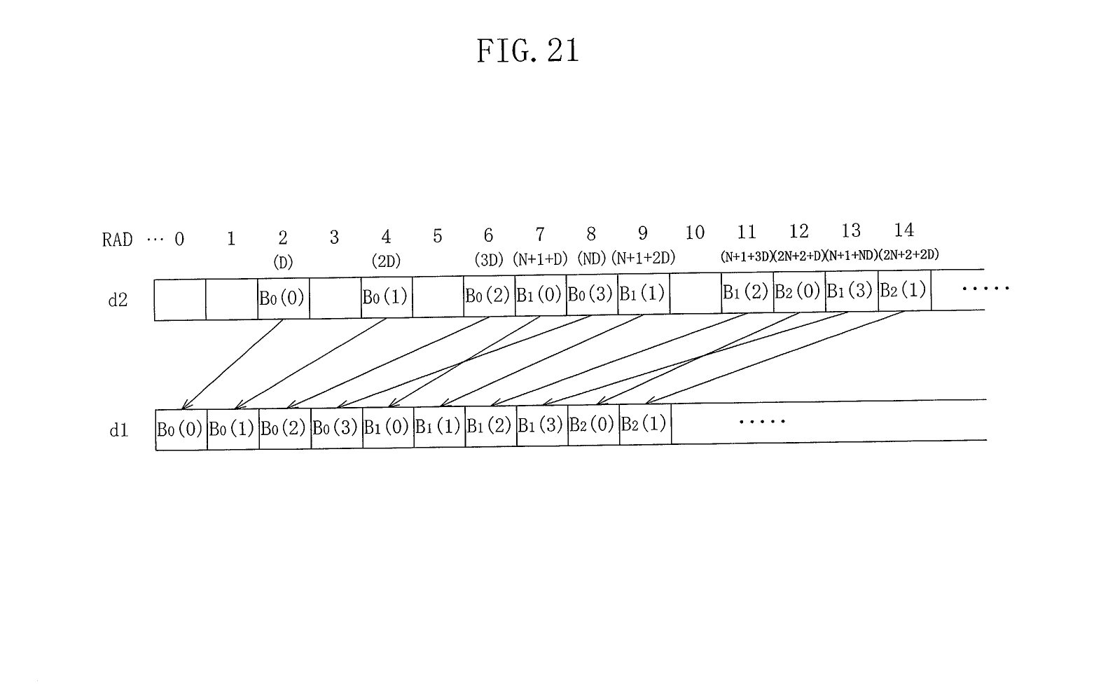

The data read from the memory 1900 is output to the outside as output data d1. As shown in FIG. 21, by the de-interleave operation of the de-interleave circuit 1300, the byte data arrangement of the input data d2 is restored to the original arrangement (i.e., the arrangement before the interleave operation of the interleave circuit 1200 of FIG. 14).

(b) When the Frame Length N is an Odd Number

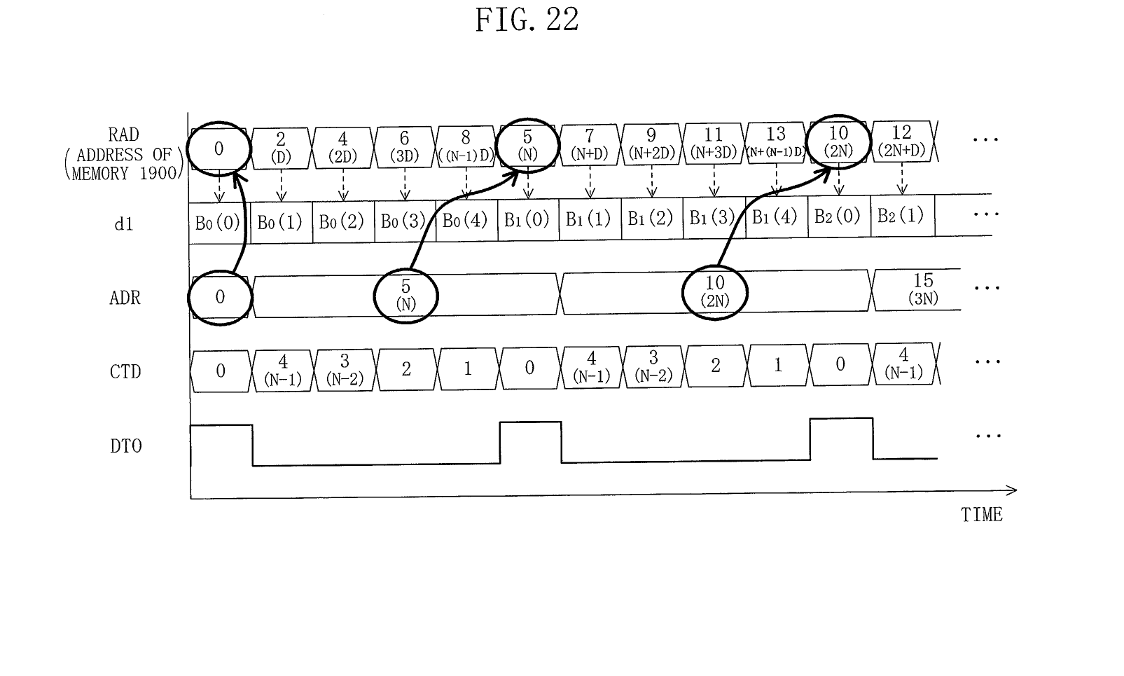

Description will now be given with reference to FIG. 22. It is herein assumed that the frame length N is 5 and the interleave depth D is 2.

As shown in FIG. 18, the data d2 is sequentially stored in the memory 1900 on a byte-by-byte basis.

Since the least significant bit LSB of the frame length N is 1, the selector 403 outputs zero. The output “0” of the selector 403 is set to the address register 404 as the initial value of the address ADR. Since the output CDT of the down-counter 206 is zero (initial value), the detection signal DT0 from the zero-detector 208 is at logical high level. In response to the logical high level detection signal DT0, the selector 1902 selects the output “0” of the address register 404. Address 0 is thus applied from the read address generator 1903 to the memory 1900 as read address RAD. In response to this, byte data B₀(0) is read from address 0 of the memory 1900.

The output CTD of the down-counter 206 becomes 4 (=N−1). In response to this, the detection signal DT0 from the zero-detector 208 goes to logical low level. In response to this, the address register 404 updates the address ADR to the output A3 (5=N+0) of the adder 405. In response to the logical low level detection signal DT0, the selector 1902 selects the output A21 (2=D=0+D) of the adder 1901.

Address 2 (=D) is thus applied from the read address generator 1903 to the memory 1900 as read address. In response to this, byte data B₀(1) is read from address 2 (=D) of the memory 1900.

Byte data B₀(2), B₀(3) and B₀(4) are respectively read from addresses 4 (=2D), 6 (=3D) and 8 (=(N−1)D) of the memory 1900 in the same manner as that of the byte data B₀(1).

The output CTD of the down-counter 206 becomes zero. In response to this, the detection signal DT0 from the zero25 detector 208 goes to logical high level. In response to the logical high level detection signal DT0, the selector 1902 selects the output ADR (=5=N) of the address register 404. Address 5 (=N) is thus applied from the read address generator 1903 to the memory 1900 as read address RAS. In response to this, byte data B₁(00) is read from address 5 (=N) of the memory 1900.

The output CTD of the down-counter 206 becomes 4 (=N−1). In response to this, the detection signal DT0 from the zero-detector 208 goes to logical low level. In response to this, the address register 404 updates the address ADR to the output A3 (10=N+N=2N) of the adder 405. In response to the logical low level detection signal DT0, the selector 1902 selects the output A21 (7=N+D) of the adder 1901. Address 7 (=N+D) is thus applied from the read address generator 1903 to the memory 1900 as read address. In response to this, byte data B₁(1) is read from address 7 (=N+D) of the memory 1900. Thereafter, the same process as that described above is repeated.

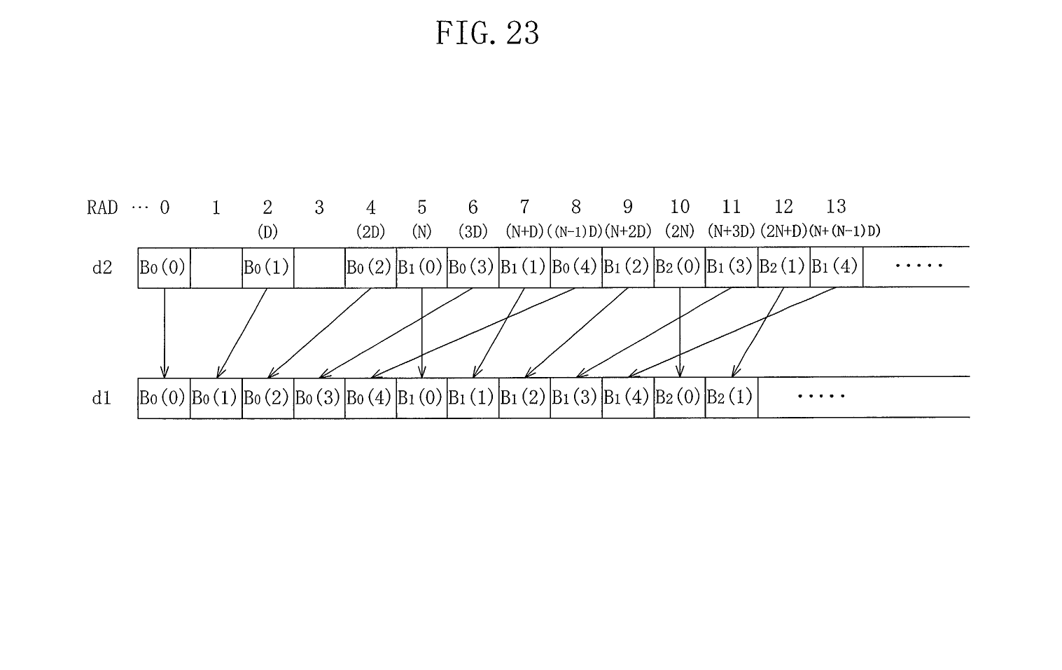

The data thus read from the memory 1900 is output to the outside as output data d1. As shown in FIG. 23, by the de-interleave operation of the de-interleave circuit 1300, the byte data arrangement of the input data d2 is restored to the original arrangement (i.e., the arrangement before the interleave operation of the interleave circuit 1200 of FIG. 14).

[Effects]

As has been described above, the de-interleave circuit 1300 of the fourth embodiment realizes the de-interleave operation by switching the read-address generation and control mechanism and the write-address generation and control mechanism of the interleave circuit 1200 of FIG. 14 with each other. As a result, the data d2 resulting from the convolutional interleave operation of the interleave circuit 1200 of FIG. 14 can be restored to the original data d1 (i.e., the data before the convolutional interleave operation).

[Modification]

Note that the above description is given for the case where the frame length N of the input data d1 is 4 and 5. However, the de-interleave operation can be conducted in the same manner as that described above even when the input data d1 has another frame length N.

Moreover, the above description is given for the case where the interleave depth D is 2. However, the de-interleave operation can be conducted in the same manner as described above even when the interleave depth D has another value (where D is 2ⁿ (n is a positive integer)).

Another structure is also possible in order to reduce the memory region to be used in the memory 1900 as much as possible. More specifically, the read address generator 1903 and the write address generator 1904 may be structured as follows: If the frame length N is an odd number, the write address WAD and the read address RAD are reset to the initial value “0” when they exceed (frame length N)×(interleave depth D). If the frame length N is an even number, the write address WAD and the read address RAD are reset to the initial value “0” when they exceed (N+1)×D. The memory region to be used in the memory 1900 is thus N×D bytes when the frame length N is an odd number, and (N+1)×D bytes when the frame length N is an even number.

The memory 1900 may be replaced with a FIFO buffer.

(Fifth Embodiment)

[Structure of ADSL Modem]

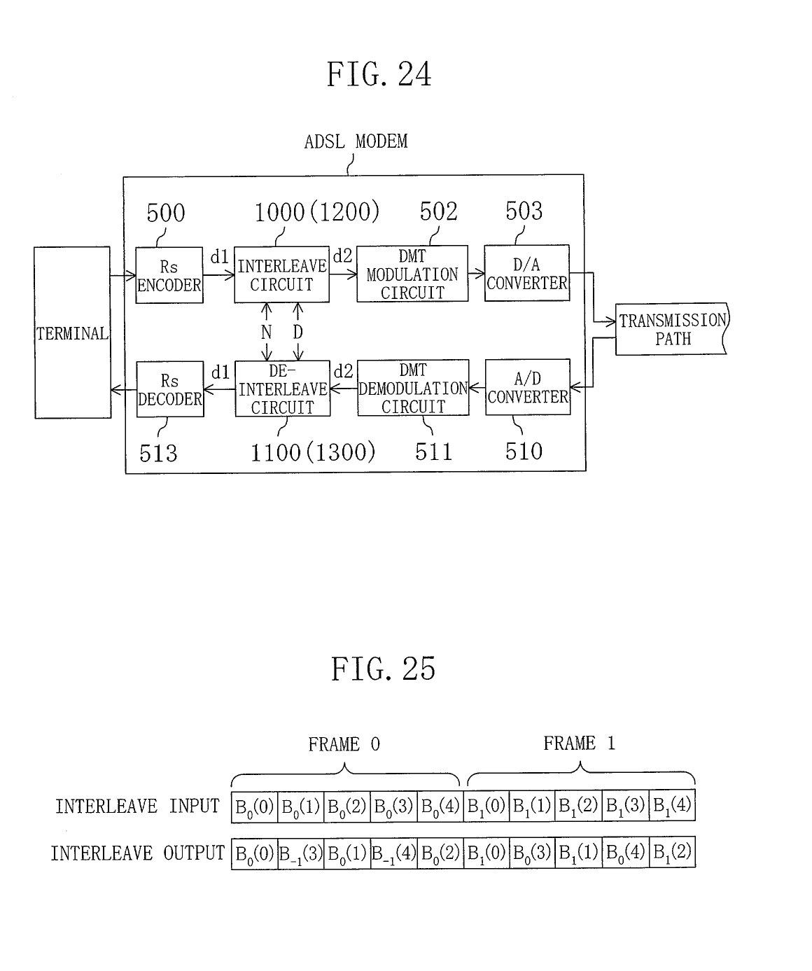

FIG. 24 is a block diagram of the structure of an ADSL modem (xDSL modem) according to the fifth embodiment of the present invention. The ADSL modem of FIG. 24 includes an RS (Reed-Solomon) encoder 500, an interleave circuit 1000 (1200), a DMT (Discrete Multi-Tone) modulation circuit 502, a D-A (digital-to-analog) converter 510, an A-D (analog-to-digital) converter 510, a DMT demodulation circuit 511, a de-interleave circuit 1100 (1300), and an RS decoder 513.

The RS encoder 500 encodes input data from a terminal according to a Reed-Solomon coding method, and outputs the resultant data to the interleave circuit 1000 (1200). The interleave circuit 1000 (1200), which is the interleave circuit of FIG. 1 (FIG. 14), rearranges the Reed-Solomon coded data d1 by the convolutional interleave operation, and outputs the resultant data to the DMT modulation circuit 502 as data d2. The DMT modulation circuit 502 DMT-modulates the data d2 from the interleave circuit 1000 (1200). The D-A converter 503 converts the DMT-modulated data into analog signal for output to a transmission path. The A-D converter 510 converts the analog signal from the transmission path into digital signal. The DMT demodulation circuit 511 DMT-demodulates the digital signal thus obtained by the A-D converter 510. The de-interleave circuit 1100 (1300), which is the de-interleave circuit of FIG. 9 (FIG. 19), restores the DMT-demodulated data to the original byte data arrangement by the de-interleave operation, and outputs the resultant data to the RS decoder 513 as data d1. The RS decoder 513 conducts error correction of the data d1 from the de-interleave circuit 1100 (1300) according to a Reed-Solomon coding method, and outputs the resultant data to the terminal.

[Operation of ADSL Modem]

In the ADSL, the state of a transmission path for communications varies depending on the situations. Therefore, a transmitting ADSL modem and a receiving ADSL modem together determine the code length (frame length) N of the Reed-Solomon coded data and the interleave depth D in the initialization routine in view of the communication state. It should be noted that the interleave depth D is set to 2ⁿ (where n is a positive integer). The code length (frame length) N and the interleave depth D thus determined are applied to the interleave circuit 1000 (1200) and the de-interleave circuit 1100 (1300).

When transmitting the data from the terminal to the transmission path, the ADSL modem first adds a correction bit of the Reed-Solomon code to the input data from the terminal by the RS encoder 500. The resultant data is then subjected to the convolutional interleave operation of the interleave circuit 1000 (1200), DMT modulation of the DMT modulation circuit 502, and conversion into analog signal by the D-A converter 503, and then is output to the transmission path.

When transferring the received data from the transmission path to the terminal, the ADSL modem first converts the analog data from the transmission path into digital data by the A-D converter 510. The digital data thus obtained is then DMT-demodulated by the DMT demodulation circuit 511, and restored by the de-interleave circuit 512. Thereafter, the resultant data is subjected to error-correction by the RS decoder 513, and then is transferred to the terminal.

[Effects]

As has been described above, the ADSL modem of the fifth embodiment includes the interleave circuit 1000 (1200) of FIG. 1 (FIG. 14) and the de-interleave circuit 1100 (1300) of FIG. (FIG. 19), enabling implementation of the ADSL modem cording to ITU recommendations G.992.1 and G.992.2.

What is claimed is:

1. An interleave circuit, comprising:
a first memory for storing a plurality of frames each including N data (where N is a positive integer);
a first read address generating section for sequentially applying to the first memory a read address for reading each of the N data included in each frame stored in the first memory;
a second memory; and
a first write address generating section for applying to the second memory a write address for writing to the second memory the data read from the first memory according to the read address from the first read address generating section,
wherein when N is an even number, the first read address generating section applies twice in succession to the first memory a read address for reading one of the N data included in each frame stored in the first memory,
the first write address generating section applies as the write address to the second memory an address that is incremented by an interleave depth in response to every write access to the second memory,
when N is an even number, the first write address generating section applies a sum of the number of frames that have already been transferred from the first memory to the second memory and a read address of one of the data in each frame that is first read from the first memory as a write address for writing the data first read from the first memory to the second memory, and
when N is an odd number, the first write address generating section applies the read address of the data first read from the first memory as the write address for writing the data first read from the first memory to the second memory.

2. The interleave circuit according to claim 1, wherein the interleave depth is 2ⁿ (where n is a positive integer).

3. The interleave circuit according to claim 1, wherein when N is an even number, the first read address generating section applies to the first memory twice in succession a read address for reading head data of each frame stored in the first memory.

4. The interleave circuit according to claim 1, further comprising:
a register for storing dummy data; and
a selector for selectively applying to the second memory the dummy data stored in the register or the data read from the first memory,
wherein when N is an even number, the selector applies to the second memory the dummy data stored in the register instead of the one of the N data that is read twice in succession from the first memory.

5. The interleave circuit according to claim 1, wherein each of the N data included in each of the plurality of frames is byte data.

6. A circuit for de-interleaving data interleaved by the interleave circuit according to claim 1, comprising:
a third memory for storing the data interleaved by the interleave circuit;
a second read address generating section for applying to the third memory a read address for reading each of the data stored in the third memory;
a fourth memory; and
a second write address generating section for applying to the fourth memory a write address for writing to the fourth memory the data read from the third memory according to the read address from the second read address generating section,
wherein the second read address generating section applies as the read address to the third memory an address that is incremented by the interleave depth in response to every read access to the third memory,
when N is an even number, the second read address generating section applies a sum of the number of frames that have already been transferred from the third memory to the fourth memory and a write address for writing one of the data in each frame that is first read from the first memory of the interleave circuit to the fourth memory as a read address for reading from the third memory the data first read from the first memory,
when N is an odd number, the second read address generating section applies the write address for writing the data that is first read from the first memory to the fourth memory as the read address for reading from the third memory the data first read from the first memory, and
when N is an even number, the second write address generating section applies twice in succession to the fourth memory a write address for writing the one of the N data that is read twice in succession from the first memory of the interleave circuit.

7. An xDSL modem comprising the interleave circuit according to claim 1.

8. An xDSL modem comprising the de-interleave circuit according to claim 6.

9. An interleave circuit, comprising:
a first memory;
a write address generating section for sequentially applying to the first memory a write address for writing each of N data included in each of a plurality of frames (where N is a positive integer);
a first address register for generating, when N is an odd number, a value that has an initial value “0” and that is incremented by N every time N data are written to the first memory, and generating, when N is an even number, a value that has an initial value equal to an interleave depth and that is incremented by (N+1) every time N data are written to the first memory; and
a first adder for incrementing the write address from the write address generating section by the interleave depth in response to every write access to the first memory,
wherein the write address generating section applies an output of the first address register as a write address for writing head data of each frame to the first memory, and applies an output of the first adder as a write address for writing data other than the head data of each frame to the first memory.

10. The interleave circuit according to claim 9, wherein the interleave depth is 2ⁿ (where n is a positive integer).

11. The interleave circuit according to claim 9, wherein each of the N data included in each of the plurality of frames is byte data.

12. A circuit for de-interleaving data interleaved by the interleave circuit according to claim 9, comprising:
a second memory for storing the data interleaved by the interleave circuit;
a read address generating section for applying to the second memory a read address for reading each data stored in the second memory;
a second address register for generating, when N is an odd number, a value that has an initial value “0” and that is incremented by N every time N data are read from the second memory, and generating, when N is an even number, a value that has an initial value equal to the interleave depth and that is incremented by (N+1) every time N data are read from the second memory; and
a second adder for incrementing the read address from the read address generating section by the interleave depth in response to every read access to the second memory,
wherein the read address generating section applies an output of the second address register to the second memory as a read address every time N data are read from the second memory, and otherwise applies an output of the second adder to the second memory as a read address.

13. An xDSL modem comprising the interleave circuit according to claim 9.

14. An xDSL modem comprising the de-interleave circuit according to claim 12.
